(19) United States
(12) Patent Application Publication
(10) Pub. No.: US 2009/0299901 A1
(43) Pub. Date: Dec. 3, 2009

(54) AUTOMATED REMITTANCE MACHINE AND METHOD

(75) Inventors: Rommel Roque Garcia, Aliso Viejo, CA (US); Manuel Vicente Acuna Arnaldo, Los Angeles, CA (US); Jose Romualdo Fazon Francisco, Los Angeles, CA (US); Antonio Cabalza Madrid, Aliso Viejo, CA (US)

Correspondence Address: FITCH EVEN TABIN & FLANNERY, 120 SOUTH LASALLE STREET, SUITE 1600, CHICAGO, IL, 60603-3406, US

(73) Assignee: PNB REMITTANCE CENTERS, INC., Los Angeles, CA (US)

(21) Appl. No.: 12/473,840

(22) Filed: May 28, 2009

Related U.S. Application Data
(60) Provisional application No. 61/057,160, filed on May 29, 2008.

(51) Int. Cl. G06Q 40/00

(52) U.S. Cl. 705/43; 705/44; 455/466

(57) ABSTRACT

A method for use in remitting funds, including establishing a self-service apparatus in a location accessible by members of the public, allowing unrestricted access to input/output devices of the self-service apparatus, receiving from the self-service apparatus funds remittance information that is entered into the self-service apparatus by a user interacting with the input/output devices and remitting funds in accordance with the funds remittance information. A method includes establishing a first server that is configured to receive funds remittance information from a plurality of self-service apparatuses and determine which of a plurality of second servers is associated with a first one the plurality of self-service apparatuses. A remittance system includes a first server that is configured to perform a similar determination.

### CROSS-REFERENCE TO RELATED APPLICATIONS

This application claims the benefit of U.S. Provisional Patent Application No. 61/057,160, filed May 29, 2008, entitled “AUTOMATED REMITTANCE MACHINE AND METHOD,” the entire disclosure of which is hereby incorporated by reference herein in its entirety.

### BACKGROUND OF THE INVENTION

1. Field of the Invention

The present invention relates generally to transferring funds, and more specifically to remitting funds to another country.

2. Discussion of the Related Art

At any given time, family members and loved ones are spread across the globe. Often times, these same family members and loved ones require financial assistance for things such as daily expenses, loan payments or financial emergencies. However, transferring money safely between countries has often proven to be a difficult task. Remittance provides a migrant living and working away from his or her home country with the ability to transfer funds safely to beneficiaries in his or her home country. Remittance provides one of the largest financial inflows for developing countries. For the beneficiaries themselves, remittances are often times a steady source of funds.

### SUMMARY OF THE INVENTION

Several embodiments of the invention advantageously address the needs above as well as other needs by providing a method for use in remitting funds, comprising establishing a self-service apparatus in a location accessible by members of the public, allowing unrestricted access to input/output devices of the self-service apparatus, receiving from the self-service apparatus funds remittance information that is entered into the self-service apparatus by a user interacting with the input/output devices and remitting funds in accordance with the funds remittance information.

In another embodiment, the invention can be characterized as a method for use in remitting funds, comprising establishing a first server that is configured to receive funds remittance information from all of a plurality of self-service apparatuses, wherein each of the plurality of self-service apparatuses are associated with one of a plurality of second servers, receiving at the first server funds remittance information that was entered into a first of the plurality of self-service apparatuses, determining which one of the plurality of second servers is associated with the first self-service apparatus, sending at least a portion of the funds remittance information to the determined one of the plurality of second servers that is associated with the first self-service apparatus and remitting funds in accordance with the funds remittance information.

In another embodiment, the invention can be characterized as a remittance system, comprising a plurality of self-service apparatuses, a first server configured to receive remittance information from each of the plurality of self-service apparatuses and one or more second servers communicationally coupled to the first server, wherein each of the one or more second servers is associated with one or more of the plurality of self-service apparatuses, wherein, in response to receiving remittance information from a first of the plurality of self-service apparatuses, the first server is configured to determine which of the one or more second servers is associated with the first self-service apparatus and is further configured to forward at least a portion of the remittance information received from the first self-service apparatus to the determined second server.

In another embodiment, the invention can be characterized as a device for transferring funds comprising a housing, a card reader disposed within the housing and configured to accept a user membership card, wherein the user membership card initiates a transaction corresponding to transferring funds, a processing unit configured to recognize a user account corresponding to the user membership card and process the transaction, a display screen coupled to the processing unit and configured to display instructions of the transaction from the processing unit to a remitter, a user input device coupled to the processing unit and configured to receive input from the remitter and send the input to the processing unit and a communication unit coupled to the processing unit and configured to send and receive communication corresponding to the transaction.

In another embodiment, the invention can be characterized as a method for transferring funds comprising receiving remitter membership information, activating a transaction in response to receiving the remitter membership information, wherein the transaction corresponds to transferring funds, receiving a selection of at least one chosen beneficiary of the transaction from a list of at least one beneficiary from the remitter, receiving a transfer amount for the funds from the remitter, receiving user payment for the funds from the remitter, determining the validity of the user payment and transferring the funds to the at least one chosen beneficiary from the remitter in a first country in response to determining the validity of the user payment.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1A is a flow diagram illustrating a general process of remitting funds in accordance with one embodiment of the present invention.

FIG. 1B is a flow diagram illustrating a general process for performing a transaction in accordance with one embodiment of the present invention.

FIG. 1C is a system diagram illustrating an example embodiment of the general system architecture utilized with the Automated Remittance Machine (ARM).

FIG. 1D is a system diagram illustrating another example embodiment of the general system architecture utilized with the Automated Remittance Machine (ARM).

FIG. 1E is a flow diagram illustrating a process for performing a transaction on board of a ship in accordance with one embodiment of the present invention.

FIG. 2 is a flow diagram illustrating the process of remitter beneficiary maintenance in accordance with one embodiment of the present invention.

FIG. 3 is a flow diagram illustrating the process to enroll a client into the remittance kiosk of the ARM in accordance with one embodiment of the present invention.

FIG. 4 is a flow diagram illustrating the process for a client to sign into a remittance kiosk of the ARM in accordance with one embodiment of the present invention.

FIG. 5A is a flow diagram illustrating the client interaction with the remittance kiosk of the ARM in accordance with one embodiment of the present invention.

FIG. 5B is a flow diagram illustrating the process of processing a transaction at the remittance kiosk server in accordance with one embodiment of the present invention.

FIG. 6 is a flow diagram illustrating remittance kiosk administration in accordance with one embodiment of the present invention.

FIG. 7 is a system diagram illustrating remittance kiosk report generation in accordance with one embodiment of the present invention.

FIG. 8 is an example of the display screen of the ARM in accordance with one embodiment of the present invention.

FIG. 9 is a flow diagram illustrating online transactions utilizing the ARM in accordance with one embodiment of the present invention.

FIG. 10 is a flow diagram illustrating non-online transactions utilizing the ARM in accordance with one embodiment of the present invention.

FIG. 11 is a system diagram illustrating the grouping of kiosks and servers in accordance with one embodiment of the present invention.

FIG. 12 is an illustration of a touch screen computer utilized in the ARM in accordance with one embodiment of the present invention.

FIG. 13 is an illustration of a receipt printer utilized in the ARM in accordance with one embodiment of the present invention.

FIGS. 14A, 14B, 14C and 14D are illustrations of example embodiments of kiosks of the ARM.

FIG. 15 is an illustration of a sign-on screen in accordance with one embodiment of the present invention.

FIG. 16 is an illustration of a terms of service screen in accordance with one embodiment of the present invention.

FIG. 17 is an illustration of a welcome screen in accordance with one embodiment of the present invention.

FIG. 18 is an illustration of a beneficiary screen in accordance with one embodiment of the present invention.

FIG. 19 is an illustration of a remittance purpose screen in accordance with one embodiment of the present invention.

FIG. 20 is an illustration of a mode of payment screen in accordance with one embodiment of the present invention.

FIG. 21 is an illustration of a transfer amount screen in accordance with one embodiment of the present invention.

FIG. 22 is an illustration of a swipe debit/credit card screen in accordance with one embodiment of the present invention.

FIG. 23 is an illustration of a security code screen in accordance with one embodiment of the present invention.

FIG. 24 is an illustration of a transaction preview screen in accordance with one embodiment of the present invention.

FIG. 25 is an illustration of a transaction reference screen in accordance with one embodiment of the present invention.

FIG. 26 is an illustration of a thank you screen in accordance with one embodiment of the present invention.

FIG. 27 is an example of a printed receipt in accordance with one embodiment of the present invention.

FIG. 28 illustrates a simplified block diagram of a processor-based system for implementing methods described according to one or more embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. In addition, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Remittances are typically facilitated at the specific financial institution between a teller and a customer who wishes to transfer funds to one or more beneficiaries in another country. While remittances allow a customer (also known as a remitter or remitter client) to transfer funds safely, the customer is limited to the hours of operation of the bank or other financial institution providing the remittance services. However, an emergency or crisis may occur and the customer may need to send funds during hours when the financial institution is closed. Furthermore, often times the customer is unable to go to the financial institution during normal hours of operation due to his or her work schedule, or the financial institution may be in an inconvenient location for the customer to visit.

The various embodiments of the invention provide a convenient alternative for the customer to remit funds to various beneficiaries. For example, a remittance kiosk or Automated Remittance Machine (ARM) may be placed at public locations (such as grocery stores, restaurants, hospitals, ship, etc.) which are accessible at hours beyond the financial institution. The customer would then have the ability to use the self-service ARM to remit money at any given time without being restricted to the time and geographical constraints of the financial institution. Throughout the specification, references are made to the Automated Remittance Machine (ARM) or a remittance kiosk, it should be noted that these terms are often interchanged.

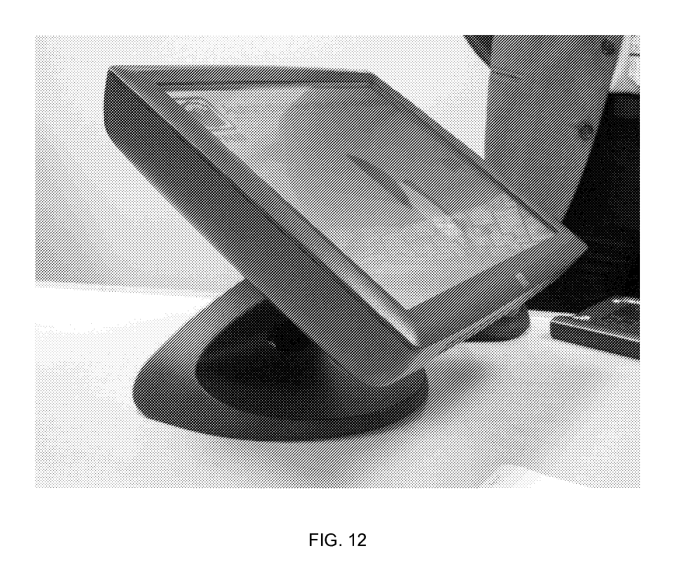

The remittance system generally employs touch-screen based self-service kiosks, for example as illustrated and described in FIG. 12 below. In one or more embodiments, the system further employs thermal receipt printers such as those illustrated and described in FIG. 13 below. In some embodiments, the system further includes a Remittance Kiosk Web Server, Remittance Kiosk Application Server, Remittance kiosk Database server, IRS regional branch server, and LAN cabling, all discussed below. In one embodiment, the system is provided with a kiosk point of sale or equivalent touch screen computer, magnetic stripe reader/writer, receipt printer with tear bar, USB or parallel printer port, and LAN port such as a 10/100 MHZ base Ethernet.

In one or more embodiments, the automated remittance system will introduce fully automated and innovative service using a global remittance card, such as the Global Filipino Family Card (GFFC), with all in one card and “single-swipe” enabled features in an unattended remittance counter.

One embodiment of the present invention provides a method for use in remitting funds. The method includes establishing a self-service apparatus, such as for example an ARM, in a location accessible by members of the public. Unrestricted access is allowed to the input/output devices of the self-service apparatus, such as for example an LCD screen and/or card swipe or card reader device. This way, anybody can attempt to use and interact with the input/output devices of the self-service apparatus themselves. The users do not need to deal with a human teller at a bank or other financial institution at this point in the process. While anybody can attempt to use and interact with the input/output devices of the self-service apparatus, in some embodiments only registered members will be able to successfully arrange a remittance of funds. In some embodiments, only existing customers who enroll in the program will be able to arrange remittance of funds.

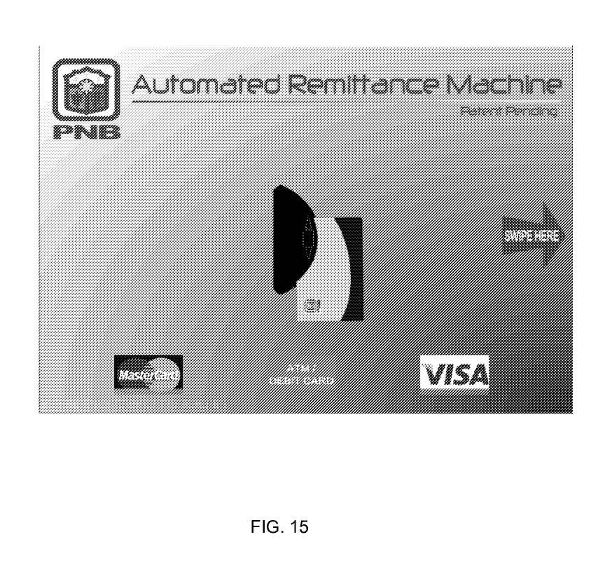

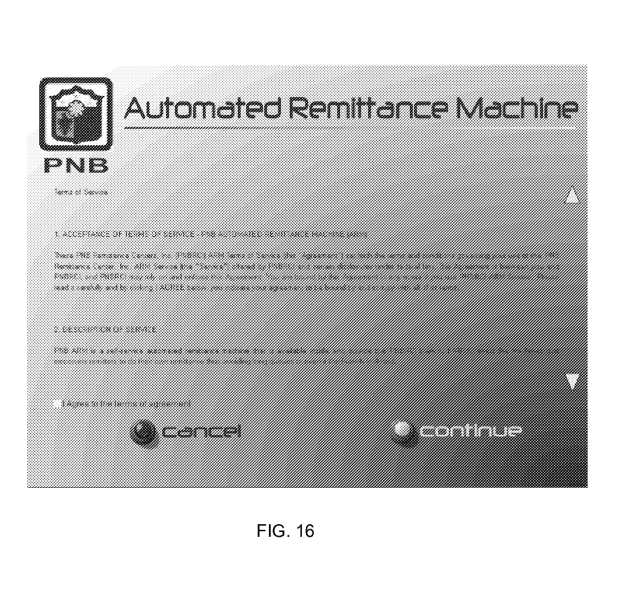

A user enters funds remittance information into the self-service apparatus by interacting with the input/output devices. An example of the funds remittance information, which typically includes the designation or selection of a beneficiary among other things, will be described below. Furthermore, an example graphical user interface for entering the funds remittance information will be described below at least with respect to FIGS. 15-26.

The funds remittance information is then received from the self-service apparatus. By way of example, the funds remittance information may be received by a bank, financial institution, remittance center, etc. The funds remittance information may be received via telephone lines, a network, the Internet, or some other means of communication. For example, an ARM may communicate with a financial institution's server via the Internet or other network. After the funds remittance information is received, a remittance of funds may be made in accordance with the funds remittance information. Namely, funds may be transferred to the designated or selected beneficiary in accordance with any other specified instructions. For example, funds may be deposited directly into the beneficiary's account, the funds may be picked up by the beneficiary, the funds may be delivered to the beneficiary, or the funds may be transferred to the beneficiary in some other way.

Thus, embodiments of the present invention allow a user to arrange a remittance of funds on his or her own using a self-service apparatus rather than having to deal with a human teller at a bank or other financial institution during that institution's hours of operation. For example, a remitter may arrange a remittance at a self-service apparatus at a train station, airport, restaurant, ship, etc., while he or she is traveling. The beneficiary, who may be located in a different country, state, continent, etc., will then receive the funds.

For example, when a remitter registers to participate in the automated remittance system, the remitter is given a user membership card. In addition, the one or more registered beneficiaries are also given user membership cards. In another embodiment, the remitter or beneficiary may have an existing card and the remittance may be completed using the existing user membership card. The user membership card of the remitter may be used to activate the automated remittance machine to perform remittance transactions. On the other hand, the user membership card of the beneficiary may act as a debit or ATM card that may be used to access the remitted funds.

By way of further example, in some embodiments, the remittance of funds may be arranged from an ARM or other self-service apparatus in a number of different ways, and in any denomination. For example, in some embodiments there may be a direct credit to a bank account. It may be a direct credit to an account maintained with any foreign bank and its on-line branches all over any country. This service enables the beneficiary to withdraw funds from all online branches as well as ATMs. In some embodiments, funds may be credited the same day from date of receipt or processing at branches.

In some embodiments, the remittance of funds may be made by cash door-to-door. For cash door-to-door delivery, the funds are delivered at the residence or place indicated by the remitter. Funds may also be delivered in the form of cashier's checks, at the option of the remitter.

In some embodiments, the remittance of funds may be made by advice and pay. Beneficiaries with no bank accounts may be able to receive funds through payment at an institution's counters. They may be advised by telegram, mail or by phone to come to the nearest branch, where they are paid upon presentation of acceptable identification.

In some embodiments, the remittance of funds may be made by credit to other banks. Remitters who wish to send funds intended for beneficiaries' accounts maintained with other banks can avail of this service. Funds will be transferred to the other local banks; subsequent credit to the intended accounts may be dependent on the other banks' delivery system.

The following describes an example embodiment of an apparatus and method in accordance with an embodiment of the present invention. Throughout the exemplary embodiment, mentions of Filipinos and the Filipino Global card are made. However, it should be understood that embodiments of the invention may be applied to any country, nationality, ethnicity, state, region, continent, race, etc.

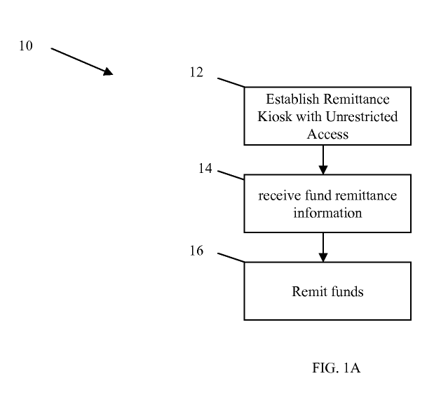

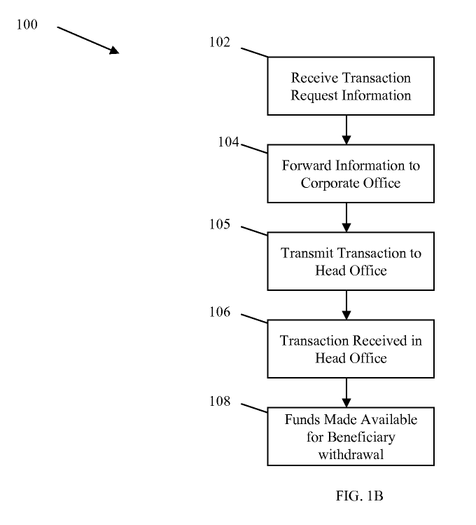

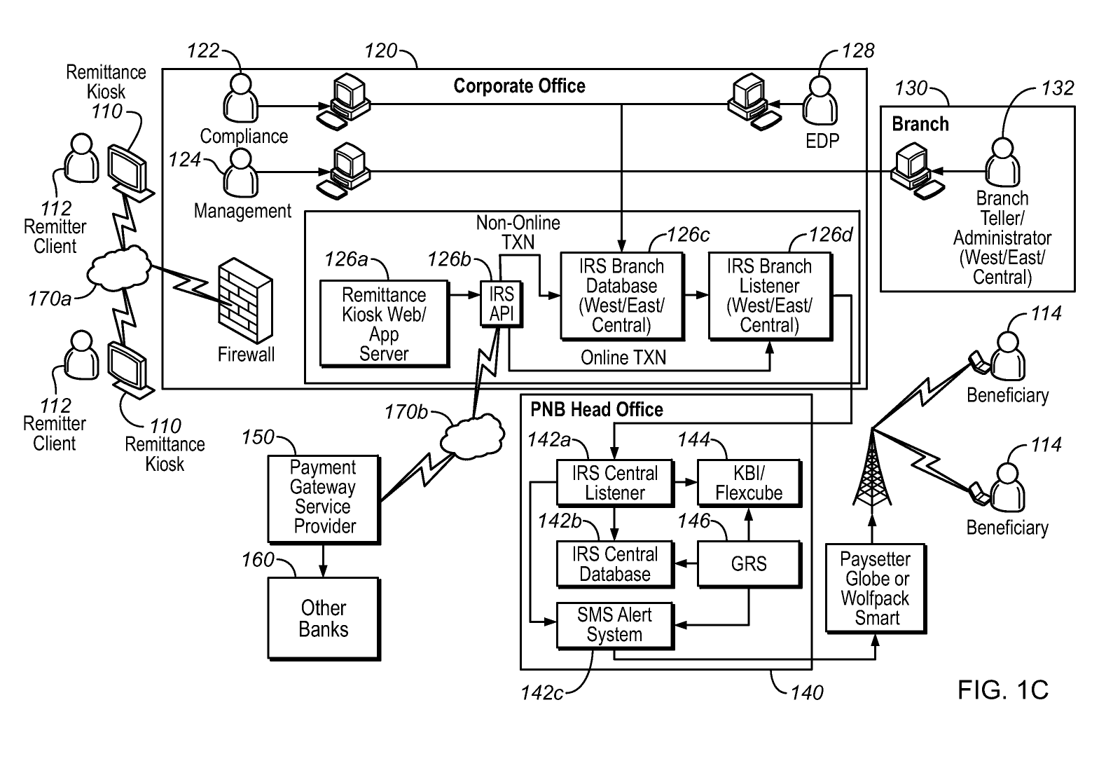

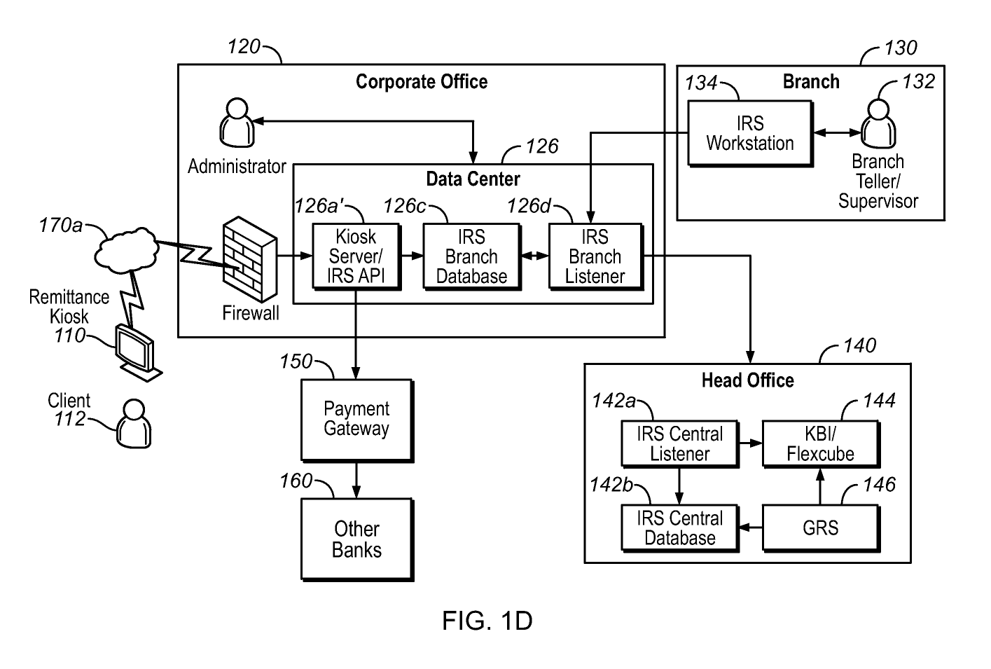

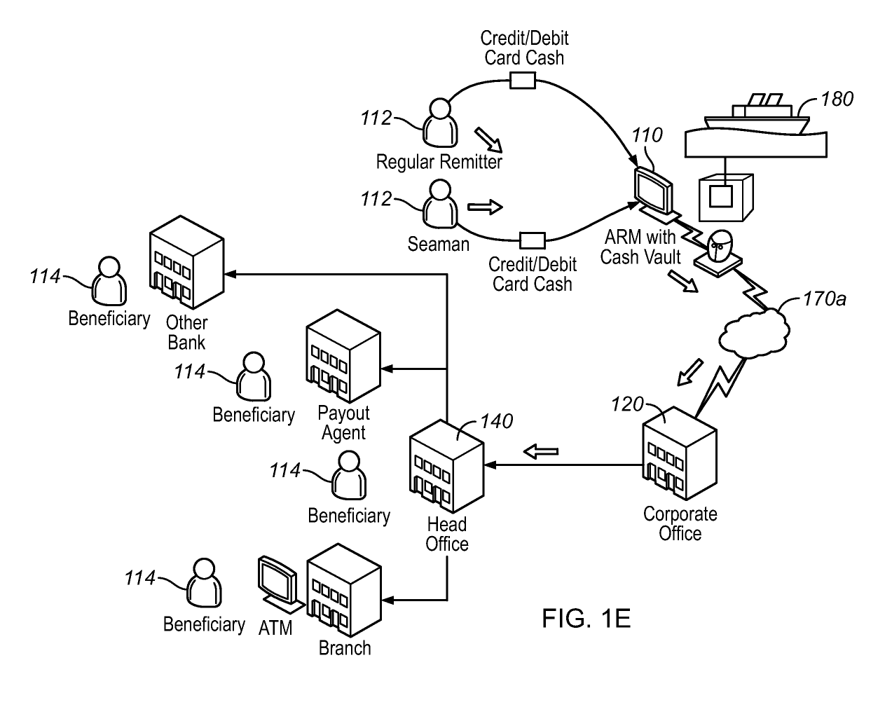

FIG. 1A is a flow diagram illustrating a general process 10 of remitting funds in accordance with one embodiment of the present invention. In step 12, one or more self service apparatuses or remittance kiosks are set up at different locations. For example, in one embodiment, the remittance kiosk or ARM is located in a public location that is accessible at any hour, such as a hospital, supermarket, on board of a ship, or at remittance center branch locations. After establishing the remittance kiosks, users are allowed unrestricted access to the self-service remittance kiosks. In one embodiment, the user is the remitter, that is, the remitter himself requests a transaction. This is different from when the remitter enters a branch and the transaction is conducted by the teller at the branch. Next, in step 14, funds remittance information entered into the self-service apparatus by the user interacting with the input/output device are received. In one embodiment, the remittance information comprises information identifying the remitter. Next, in step 16 the system remits funds in accordance with the funds remittance information.

FIG. 1B illustrates a flow diagram of a general process 100 for performing a transaction in accordance with one embodiment of the present invention. In one or more embodiments, one or more remittance kiosks may be available in restaurants, grocery stores, remittance branch locations, on board of a ship, etc. In one or more embodiments, remittance kiosks may utilize a cash vault. In step 102, the remitter enters a transaction request using credit card, debit card, cash, or other authorized forms of payment.

Next, in step 104, the information received at the ARM is forwarded to the corporate office for processing. The corporate office is usually the remitter main office. That is, in some embodiments, the corporate office is the office that hosts the servers and the remittance kiosk server, and the office with which the ARM is in communication with. In one embodiment, the ARM may communicate with the corporate office through a wireless connection. In other embodiments, the connection may be through a wired connection.

Next, in step 105, the corporate office will forward transaction information for processing the remittance to the Head Office.

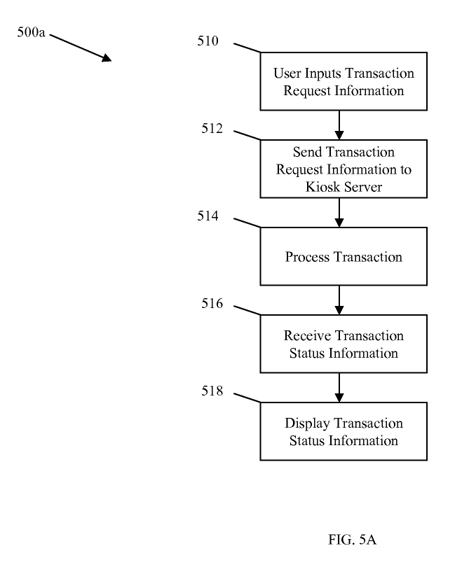

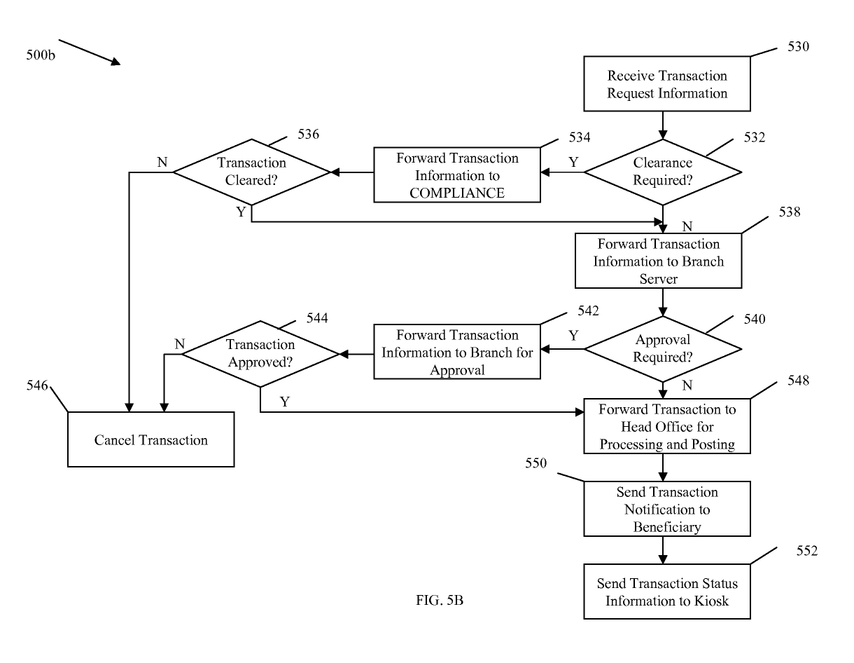

Next in step 106, the information is received at the Head Office. The transaction is then completed at the head office. Next, in step 108, the funds transferred will be made available for withdrawal by the beneficiary. In some embodiments, the transaction may be completed as described in FIG. 5B, 9 or 10. In other embodiments, the transaction may be completed at the branch and the transaction status information may be transmitted to the head office. In one embodiment, once the transaction is completed and funds are made available the funds may then be communicated to one or more payout agents, other banks, branches, or other locations for withdrawal by the beneficiary.

FIG. 1C illustrates an exemplary system architecture utilized with the ARM. The system architecture comprises one or more remittance kiosks 110, a corporate office 120, a remittance branch 130, a head office 140, a payment gateway 150, and one or more other banks 160. In one embodiment, the head office 140 refers to the main office of the financial institution that handles the processing of funds and is in communication with the branches and other banks to which the funds are remitted. In one embodiment, the head office may be located in the beneficiaries' home location or region, e.g. country, while the corporate office 120 refers to the main office located in a different country, state or region. In another embodiment, the head office is the office in communication with the branches to which the fund is remitted and hosts the elements necessary for processing the remittance transaction. The Corporate Office, according to some embodiments is the office that handles one or more branches and kiosks at which the remitter may remit from. In some embodiments, the corporate Office is the main office in the remitter's home country. In another embodiment, the Corporate Office is the branch in communication with one or more remittance kiosks and branches at which the remitter may request a remittance. The remittance branches 130 refer to the branches located where remitters/clients 112 may perform remittance transactions. The remittance branches, in some embodiments, enable remittance using tellers. In other embodiments, there may be an ARM inside the branch for remittance. For example, in one embodiment, the head office 140 refers to the main office in the Philippines while the corporate office 120 and the remittance branches 130 are located in the U.S.

The remittance kiosks 110 are utilized by a remittance client 112 to remit money to a beneficiary 114. Typically, the beneficiary 114 is located at another location, such as a different country than the remittance client 112. The remittance client may remit money to a beneficiary as generally outlined, for example, in the process of FIG. 1B

In one or more embodiments, the branch supervisor/tellers access the remittance kiosk system using the exiting network infrastructure going to the Branch Office. In some embodiments, the Management users access the remittance kiosk system use the existing LAN within the RCI corporate office. In one or more embodiments, the kiosk units access the Remittance kiosk server through a secured network connection. In one embodiment, a secured sever connection is established at the time of the communication.

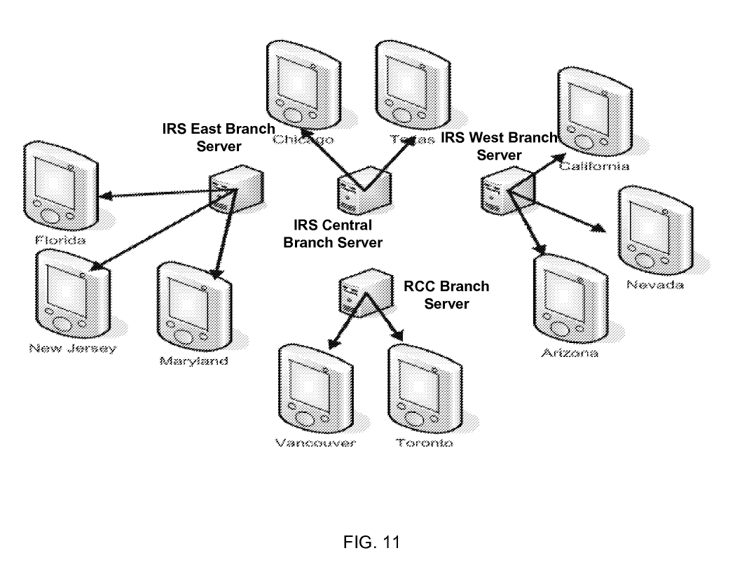

In one embodiment, the Compliance Department 122, Remittance Management Department 124 and Electronic Data Processing Department (EDP) or IT Department 128 are located at the Corporate Office 120. Further, in some embodiments, the Remittance Kiosk Server/App Server 126a and IRS API 126b are located at the Corporate Office 120. In some embodiments, the Remittance Kiosk Server 126a and IRS API 126b may be referred to as the kiosk server or remittance kiosk server. The kiosk server may refer to one or a combination of these components. The kiosk server may further comprise additional components. In one embodiment, the IRS Branch Database 126c and IRS Branch Listener 126d are also located at the corporate office 120. In some embodiments, the Branch Database 126c and IRS Branch Listener 126d may be referred to as the branch server. The branch server may refer to one or a combination of these components. In some embodiments, the Branch Server refers to a number of regional branch servers, such as the east, west and central branch servers. In some embodiments, each regional branch server may handle transactions and ARMs within a certain geographical area. FIG. 11 depicts one exemplary embodiment of the manner in which branches and ARMs are assigned to regional branch servers. In other embodiments, the branch servers may handle a different number of branches and/or ARMS based on criteria other than geographic location.

In one embodiment, the Corporate Office 120 is in communication with the Head Office 140 through the branch servers. In some embodiments, for example, the corporate office 120 is in communication with the Home Office 140 through the regional IRS Branch Listeners 126d. The Corporate Office 120 is in communication with several different branches 130 and further in communication with the Head Office. Each branch 130 has one or more teller/administrators 132. The Head Office 140 comprises an IRS Central Listener 142a in communication with the IRS Central Database 142b, and may further comprise an SMS alert system 142c. In some embodiments, the IRS Central Listener 142a, the IRS Central Database 142b, and the SMS alert system 142c may be referred to as the central server. The central server may refer to one or more combinations of these components. The central server may further comprise additional components. The central server is in communication with KBI/FLEXCUBE System 144 and Global Remittance System (GRS) 146.

The remittance client 112 utilizes the remittance kiosk 110 to send funds to a beneficiary 114. Typically, the remittance client enrolls with a financial institution to utilize the remittance kiosk. In one embodiment, during enrollment the remittance client 112 is given a membership card to activate the remittance kiosk. In one embodiment, enrollment will link the remitter/beneficiary information and the modes of payment such as credit and debit card. In one embodiment, the remittance client activates the kiosk by swiping or inserting the membership card into the kiosk. In one or more embodiments, the payment gateway is in communication with other banks and the corporate office 120 through a network connection. The connections, in some embodiments, may be a wired or wireless connection, for example through the internet or local area network.

While using the kiosk 110, the remittance client 112 provides payment for the funds. The information is then forwarded to the corporate office 120 for processing. In one embodiment, when the payment is in the form of a credit or debit card, the membership information tied with the membership card and the payment information of the credit or debit card, e.g., the account number of the credit or debit card, is sent to the payment gateway service provider 150 through the corporate office 120 of the financial institution. In one embodiment, the transaction information is forwarded to the remittance kiosk server, and the remittance kiosk server forwards the information to the payment gateway for verification. In one embodiment, the information is sent via a network 170b. The network 170b can be a wired or wireless connection. The payment gateway service provider 150 facilitates validation of the payment by the remittance client since the payment gateway service provider 150 has access to the database of other banks 160 and other financial institutions.

In one embodiment, the gateway service provider 150 analyzes the name associated with the membership card along with the name associated with the payment card, either a credit or debit card. If the names do not match, then there is a high likelihood of fraud and the payment gateway service provider 150 returns information regarding the mismatch to the automated remittance system. The automated remittance system receives the information regarding the mismatch and then proceeds to invalidate the transaction of the remittance client. If however, the names do match, then the automated remittance system receives information regarding the match from the payment gateway service provider 150 and then proceeds to validate the transaction of the remittance client. In some embodiments, the billing address associated with the payment card is utilized for validating payment by the remittance client.

In one embodiment, the information regarding various matches and mismatches may be communicated through response codes. In one embodiment, when the remitter chooses to pay with a debit or credit card, information regarding the remitter's account tied to the user membership card (GFC) along with the account number of the debit or credit card is sent to the payment gateway. In some embodiments, the corporate office is in communication with the payment gateway through a wireless connection, while in other embodiments the connection may be a wired connection. In one embodiment, the payment gateway 150 may access a database of banks and other financial institutions 160 and return a response such as a response code, text or other indication regarding the validity of the payment.

For example, the response code could return that the name on the account number of the debit or credit card matches the name associated with the user membership card and that the payment is accepted. On the other hand, the response code could return that the names do not match each other, and the payment is not accepted. Other response codes may also be sent, in additional or alternative embodiments, for example stating that the account number is a valid number, that the pin or security entered is a valid number, etc. In such exemplary embodiments, the ARM may use these response codes to determine whether the transaction is valid. In other embodiments where the remitter chooses to pay with cash, the ARM validates the transaction by checking the imprint or image of each bill (or cash note) loaded into the ARM. In some embodiments, the ARM includes a cash or currency reader, which reads the image of each bill or cash note loaded into the ARM. If the amount of cash scanned is equal to the payment amount, then the transaction is valid.

Once the transaction to remit funds has been validated, the automated remittance system proceeds with remitting funds to the beneficiary through the corporate office 120 and the head office 140 as depicted for example in FIG. 1C.

FIG. 1D illustrates another example of a system architecture utilized with the ARM. The system architecture comprises a remittance kiosk 110, corporate office 120, Remittance Branch 130, Head Office 140, a Payment Gateway 150, and one more other banks 160. In some embodiments, the branch is the branch in the remitter's home location, and the corporate office 120 refers to the main office that handles the transactions and remittances of a number of branches including the branch 130. The Corporate Office, according to some embodiments, is located in the country in which the remitter's branch or ARM is located. In some embodiments, the home office is the main office that handles the transactions of the branch or other banks receiving the remittance funds. In one embodiment, the Home Office may be located in the home country of the beneficiary. In other embodiments, the Home office may be located in another country, but may be in communication with a branch or other bank receiving the remittance funds. The Client/Remitter 112 can remit money using the remitter kiosk 110. The Remitter Kiosk 110 is in communication with the Corporate Office via network 170a. The network 170a may be a wired or wireless connection. The corporate office is in turn in communication with Payment Gateway 150 through network 170b and the Head Office 140. The Payment Gateway is in communication with one or more other banks 160.

In one or more embodiments, the branch supervisor/tellers access the remittance kiosk system using the exiting network infrastructure going to the Branch Office 130. In some embodiments, the Management users access the remittance kiosk system use the existing LAN within the corporate office 120. In one or more embodiments, the kiosk units access the Remittance kiosk server through a secured network connection. In one embodiment, a secured sever connection is established at the time of the communication.

The Corporate Office 120 comprises a data center 126. The data center 126 comprises the Remittance Kiosk Server and Application Interface System (API) 126a′, as well as the IRS Branch Database 126c and IRS Branch Listener 126d (collectively referred to as Branch Server). In some embodiments Kiosk Server 126a′ comprises the kiosk server 126a and API 126b of FIG. 1C. The IRS branch database may comprise one or more databases each corresponding to a group of branches and ARMS. In one embodiment, the Branch Server comprises multiple regional branch servers (i.e. regional branch databases and regional branch listeners). FIG. 11 illustrates an exemplary embodiment of the different possible Branch Servers.

In one embodiment, the Corporate Office 120 may only comprise the regional Branch Servers corresponding to branches and ARMs within or near a certain country, or geographical region. In these embodiments, the overseas branch server, or the branch servers outside the graphical region, such as the RCC branch server depicted in FIG. 11, will be maintained at one or more different offices other than the Corporate Office 120. In such embodiment, the office maintaining these servers may be structurally similar to the corporate office 120. In another embodiment, the different offices may be structurally different from the corporate office 120. In some embodiments, all of the servers will be maintained at the corporate office 120 regardless of their geographical location. In some embodiments, the branch 130 is in communication with the branch server. In embodiments, where the branch server comprises one or more regional branch servers, the branch 130 will be in communication with the branch server assigned to it. In some embodiments, this assignment is based on the geographical location of the branch, or other criteria. In one or more embodiments, the branch 130 comprises the Branch teller/supervisor 132 and the IRS Workstation 134. In one embodiment, the branch 130 is in communication with the Head Office 140 through the IRS Branch Listener 126d. In one such embodiment, the IRS branch listener 126d is in communication with the head office through the IRS Central Listener 142a.

The Corporate Office 120 is in communication with one or more different branches 130 and further in communication with the Head Office. Each branch has one or more teller/administrators 132. The Head Office 140 comprises an IRS Central Listener 142a in communication with the IRS Central Database 142b (collectively referred to as the central server). The central server is in communication with KBI/FLEXCUBE System 144 and Global Remittance System (GRS) 146.

In one or more embodiments, the automated remittance system is available 24 hours a day, 7 days a week. In one or more embodiments, the system retains data for roughly 5 years. In one or more embodiments, the remittances are pushed into the Integrated Remittance System. In one or more embodiments, the system will use several security measures such as HTTPS domains, VeriSign global server IDs, User ID and passwords for users using the enrollment facility, Global Remittance Cards for clients, card pins residing on servers, encrypted communications, and pre-enrollment of beneficiaries and credit/debit cards, etc.

In one or more embodiments, all transactions and system activity is logged for monitory and/or other purposes. For example, in one or more embodiments the transactions and system activity is logged into the Remittance kiosk audit log table and log files. In some embodiments, the system employs standard database backup and restore procedures to ensure the integrity of the system.

In one or more embodiments, the Remittance Kiosk client may run on various operating systems. For example in an exemplary embodiment, the remittance kiosk client may operate using the Microsoft Windows XP Professional operating system with service packs 2 or service pack 3. The remittance kiosk server may also run on different operating systems. In one embodiment, the Remittance Kiosk Server utilizes the Microsoft windows 2003 server standard edition or later versions. In one or more embodiments, the remittance kiosk server further utilizes internet information services, Microsoft SQL server 2000 with service pack 4 or later, and VeriSign global Server ID to enable SSL.

In some embodiments, the system is able to handle any methods of SQL injection attacks. It is also able to handle filtering alphanumeric or other characters that may affect the system of operation. These characters for example may be placed in an array variable that can be updated to include further illegal characters.

FIG. 1E is a flow diagram illustrating a process for performing a transaction on board of a ship 180 in accordance with one embodiment of the present invention. In one embodiment, for example, the ship may be a cruise ship. In some embodiments, seamen and cruise customers 112 may use the system regardless if it is docked on port or out on sea. In one embodiment, the transaction is performed as described in FIG. 1B above. That is, in some embodiments, the seaman or ship customers request the transaction, the transaction is processed and the funds are remitted in accordance with the process 100 of FIG. 1B. As shown, for example, remittance kiosk 110 transmits the transaction information to the corporate office 120, which in turn forwards some or all of the information to the head office 140 for processing. After being processed, the funds are made available to the beneficiary 114 through one or more other banks, the head office, or a branch of the head office. In other embodiment, the funds may be provided to the beneficiary in other ways.

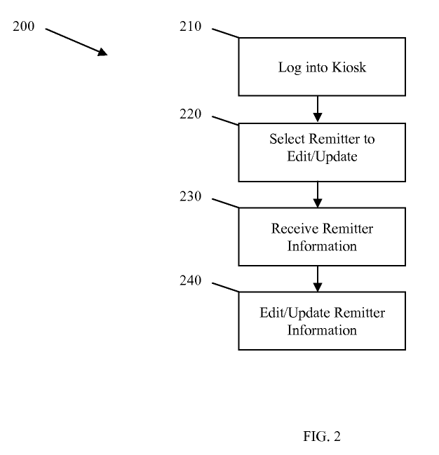

FIGS. 2-7 depict several example embodiments of various processes deployed by the automated remittance system along with the automated remittance machine.

FIG. 2 depicts a flow diagram illustrating an exemplary embodiment of remitter/beneficiary maintenance process 200. Process 200 enables a teller or supervisor from a specific branch to view, update or alter a remitter's Customer Information File (CIF). In one embodiment, the Branch teller or supervisor will be able to add, view, edit and/or delete Remitter information. In another embodiment, the Branch teller or supervisor may add beneficiaries to the Remitter. In a further embodiment, the Branch teller and/or supervisor may update remitter's transactions, view remitter's activity log, lock/unlock remitter's account, delete remitter's account, blacklist remitter's account, override global remittance amount limit, and/or override global remittance amount.

In one embodiment, process 200 is completed using the exemplary system of FIG. 1C. In another embodiment, the process may be completed in the exemplary system structure of FIGS. 1C, 1D, or some combination thereof. For example, in one embodiment, the teller/supervisor 132 located at a specific Branch 130 operates the workstation 134 to perform the remitter/beneficiary process. As further shown in FIG. 1C the Branch 130 is in communication with the Corporate Office 120.

Through the Corporate Office 120, the branch 130 has access to servers and databases, e.g. regional branch servers that provide information regarding the remittance kiosk and the Integrated Remittance System (IRS). In one embodiment, the IRS is the main remittance application used by the remittance branches in transacting remittances and the IRS regional branch server allows IRS workstations, such as the IRS workstation 134 shown in FIG. 1B, utilized by the branches, such as branch 130, to store their transaction records. In another embodiment, the remittance kiosk server interfaces with the ARM (remittance kiosk 110) and the remittance kiosk server then connects with the IRS branch server to facilitate the processing of transactions.

Process 200 begins in step 210 where the teller/supervisor logs into the kiosk. In one embodiment, there is a specific log in process for the teller/supervisor to allow the kiosk to differentiate between a teller/supervisor working for the financial institution and a customer of the financial institution. In one embodiment, for example, the teller/supervisor may swipe or insert a membership card into the kiosk that identifies the teller/supervisor as an authorized teller or supervisor of the financial institution. In some embodiments, the teller/supervisor may log into the system with a username and password. In one embodiment, the teller/supervisor utilizes a kiosk application module accessed from the teller/supervisor workstation there provides the teller/supervisor with the ability to register or update client (remitters and beneficiaries) enrolled to use the ARM.

Next, in step 220, the teller/supervisor selects the remitter to view or update. In one embodiment, upon logging in the supervisor is presented with a screen and inputs the information necessary to retrieve the remitter information. In one embodiment, after selecting a remitter, in step 230, remitter information corresponding to the selected remitter is loaded into the teller's/supervisor's screen along with other information such as beneficiaries, identification (ID) submitted, kiosk transactions, activity log and special fields. In one embodiment, special fields may include whether the remitter is blacklisted, override global remittance amount limit, unlock/lock remitter option, and channels. In one embodiment, branch teller/supervisors use this module to enroll or add new remitters or add beneficiaries associated with the remitter, update remitter's/Beneficiary's CIF, view remitter's transactions, view remitter's activity log, lock/unlock remitter's account, delete remitter's account, blacklist remitter's account, override global remittance amount limit, override global remittance amount, etc.

Once the teller/supervisor is able to view the remitter's CIF, the teller/supervisor may edit and/or update the remitter's CIF in step 240. In some embodiments, once the teller/supervisor edits and/or updates the CIF, the CIF is also updated at the Integrated Remittance System (IRS) server.

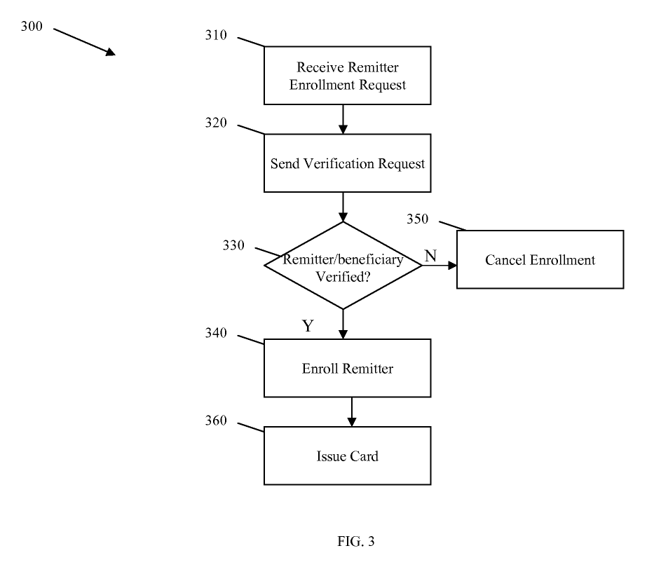

In another embodiment, the teller or supervisor may choose to add or delete a remitter. An exemplary process to add or enroll a remitter is described below with respect to FIG. 3. In one embodiment, the teller or supervisor upon logging in to the system may choose to delete a remitter account. In one embodiment upon selecting to delete the account, the information is also deleted at the IRS server.

In another embodiment, the process 200 may also enable the Management users to log into the Remittance Kiosk server. In one embodiment, the management users are users at the corporate office, and are different from the branch teller/supervisor. In one embodiment, for example the management users may log into the system using a username and password. In some embodiments, the remittance process may differentiate between the supervisor/teller and the management user. In some embodiments, the management user may have limited access. For example, in one embodiment, the management user may have view access; that is in some embodiments, the management user will be able to view Remitter's CIF, transactions, and other information. In some embodiments, the management user cannot add, delete or modify any settings. In another embodiment, the management user may have full access and will be able to perform the actions described above that the supervisor/teller is capable of performing.

FIG. 3 is a flow diagram illustrating the process to enroll a client into the remittance kiosk in accordance with one embodiment of the present invention.

In step 310, process 300 begins when the client (remitter) submits an enrollment form to a branch teller or supervisor. In an alternative embodiment, the remitter may enroll in the system by entering the required information at a self-service remittance kiosk.

In step 320, the teller/supervisor requests verification of the remitter and the one or more beneficiaries associated with the remitter. In one embodiment, the request is sent to the corporate office and the corporate office carries out the verification function. In one embodiment, the information verification is completed by the branch server. In one embodiment, the information necessary for performing the verification is stored at the branch database. In one embodiment, the information is sent from the station of the branch teller/or supervisor at the branch to the corporate office which then accesses the IRS regional branch server. In another embodiment, the information necessary to verify the remitter and beneficiaries is presented on the enrollment form. In one embodiment, the information may be retrieved from one or more other sources such as databases or servers, e.g., the branch server. In one embodiment, in order to verify the remitter and beneficiary, the system, e.g., the branch server, determines whether the remitter and beneficiary information is complete and further determines if the remitter and beneficiary are qualified on the Office of Foreign Assets Control (OFAC) and whether they are on the Blacklist. In another embodiment, additional criteria may be verified in addition or instead of the above criteria.

Next in step 330, the system determines whether the remitter and the beneficiaries associated with that remitter are eligible to enroll based on the findings in step 320. In one embodiment, if the system determines that the information is complete, and the remitter and the beneficiaries are not qualified on the Office of Foreign Assets Control (OFAC) list or on the Blacklist, then the remitter and their beneficiaries are verified to enroll to utilize the remittance kiosk. Additional criteria may also have to be met before the client is verified. If in step 330 the IRS determines that the remitter or one or more beneficiaries were qualified on the OFAC list or in the Blacklist, and then the remitter and the beneficiaries may not be enrolled, therefore, the process moves to step 350 where the enrollment process is terminated. In one embodiment, a message may be displayed to the remitter indicating that the enrollment was canceled. In some embodiments, the error message may be different for each scenario to indicate to the user exactly the reason for the cancellation. In another embodiment, if the remitter information is complete, and the remitter is not qualified on the Office of Foreign Assets Control (OFAC) list or on the Blacklist, but one or more beneficiaries are qualified on the OFAC list or in the Blacklist then the remitter is verified to enroll but the one or more beneficiaries qualified on the OFAC list or in the blacklist are not associated with the remitter.

If in step 330 it is determined that the remitter and beneficiary are eligible to enroll, the process proceeds to step 340 and the teller/supervisor enrolls the Remitter into the Remittance Kiosk system (automated remittance system). In one embodiment for example, in step 330, the teller enters the remitter and beneficiary information. In one embodiment, the teller/supervisor may access additional information from the IRS regional branch server, and or other databases or servers. In one embodiment, the remitter information comprises information such as the full name of the remitter (first, middle and last), complete address (building, street, apartment number, city, state and zip code, etc.), home phone number, birthday, and at least one form of identification (such as a state identification, driver's license or social security number).

In one embodiment, the beneficiary information includes the full name of the beneficiary (first, middle and last), complete address (building, street, apartment number, city, state and zip code, etc.), and account number for a financial institution (such as a PNB Account number or a Non-PNB Account Number with a Non-PNB-Bank name and branch. In one embodiment, after receiving the information the teller may determine whether the remitter information is complete and may complete the information if the remitter and/or beneficiary information is not complete. After determining that all of the information is complete, the teller may then save the information. In one embodiment, the information is locally saved, while in other embodiments, the information is sent to a remote storage location. For example, in one embodiment, the information is stored at the branch server located at the corporate office. In one embodiment, where the branch server comprises one or more regional servers, the information is stored at the regional server assigned to the branch at which the enrollment occurs.

In one embodiment, the enrollment of the client into the IRS system such that the client is able to remit funds using the remittance kiosk includes enrolling an account for the beneficiary, which the remitted funds may be deposited to. In some embodiments, the beneficiary may access this account in their home location, e.g. country, through their own issued user membership card. In some embodiments, the enrollment of the client into the remittance kiosk includes specifying how the selected beneficiary will receive the remitted funds. For example, in various embodiments, the method in which the remitted funds may be delivered to the beneficiary and one or more of the beneficiary's address, account number, bank, etc., may be enrolled into the remittance kiosk database during step 340.

Once the information is entered and submitted to the system to be stored, in step 360, the teller/supervisor may issue a user membership card, such as the “Global Filipino Card” (GFC), to the remitter. In some embodiments, the membership card includes a membership or account number for the client. In a further embodiment, a Personal Identification Number (PIN) may be issued along with the user membership card.

In one embodiment, the enrolled beneficiary may also be provided with a user membership card (such as the GFC) tied to the account. The beneficiaries may then use their user membership card to access their account and the remitted funds through a bank teller, ATM, etc., at their home location, e.g. home country.

In some embodiments, in step 360, the teller/supervisor may issue a username and password for the client and the client may receive the username and password. In another embodiment, the client may create the user name and password on his or her own.

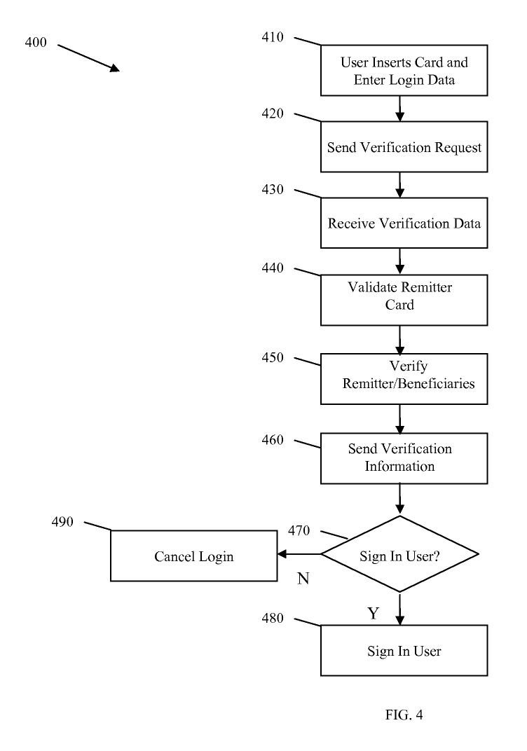

FIG. 4 illustrates a process 400 that enables a client (remitter) to sign into the remittance kiosk (ARM) in accordance with one embodiment of the present invention.

First, in step 410 the client/remitter swipes the user membership card, for example the Global Filipino Card, to sign into and activate the remittance kiosk (ARM). In one embodiment after swiping the card, the user may be prompted to accept the terms and conditions for using the kiosk. For example in one embodiment the user may be presented with a terms of use screen as is illustrated in FIG. 16. In one embodiment, the transaction is initiated when the customer swipes his/her card. In some embodiments, the data from the card is obtained from a magnetic stripe (commonly known as a Chip and Pin). In addition to Chip and PIN validation, the system may also validate the card, e.g. determine if the remitter is enrolled, and transaction validity, e.g. determine whether the maximum and minimum amount are met. In one embodiment, the remitter may enter a personal identification number (PIN) in addition to swiping the user membership card. In another embodiment, additionally or alternatively, the remitter may enter a username and password to sign into and activate the remittance kiosk (ARM). For example, in one embodiment the remitter may be presented with a sign-on screen and may enter information to sign into the system.

Once the kiosk receives the login information from the user, in step 420, the remitter membership information is forwarded to the Remittance Kiosk Server for verification. In one embodiment, the user membership information comprises information such as the account number on the remitter membership card, the remitter name, the remitter pin and/or the remitter user name.

Next in step 430, the Remittance Kiosk Server receives the membership information required for verification and validation of the remitter membership card. Next, in step 440, the server determines whether the membership information received corresponds to a valid membership account. Furthermore, in some embodiments, in step 440 the system will determine if the account is locked. For example, in one embodiment, the user membership information is the membership card number and the Remittance Kiosk server determines whether the number is valid. In one embodiment, the server may retrieve the CIF associated with the remitter account number in this step.

Next, in step 450, the Remittance Kiosk Server verifies the account by determining if the Remitter card and/or the CIF associated with the remitter and/or one or more of the beneficiaries associated with the remitter are blacklisted. For example, in one or more embodiments, the CIF may contain a blacklist indicator. Furthermore, in step 450, the remittance kiosk may also determine whether the remitter or any of the beneficiaries associated with the remitter have any OFAC findings. If in step 450 the server determines that the remitter's CIF has OFAC finding, then all transactions completed with the remitter card will be marked with OFAC findings. On the other hand, if it is determined that the remitter's CIF has no OFAC findings but one or more of the associated beneficiaries have OFAC findings, then the transactions committed with the one or more beneficiaries that have OFAC findings is marked with OFAC findings. In some embodiments, the transactions marked with OFAC findings will have to be cleared by the COMPLIANCE department before being processed.

Next, in step 460 the validation/verification status information is sent back to the remittance kiosk. In step 470, the system determines whether to log in the user. In an alternative embodiment, the determination may be made by the remittance kiosk and the result will be forwarded to the kiosk in step 460. In one embodiment, if the information indicates that the remitter card number is valid, is not locked, there are no OFAC findings for both the remitter's CIF and the beneficiaries CIF and neither the remitter nor the beneficiary is blacklisted, the process continues to step 480 and the remitter is signed on to the remittance kiosk (ARM). In another embodiment, if the information indicates that the remitter card number has been validated, is not locked and is not blacklisted, but the remitter and/or the beneficiary has OFAC findings, the process continues to step 480 and the remitter is signed on to the remittance kiosk. In one embodiment, in this scenario, as described above, transactions will be marked with OFAC findings.

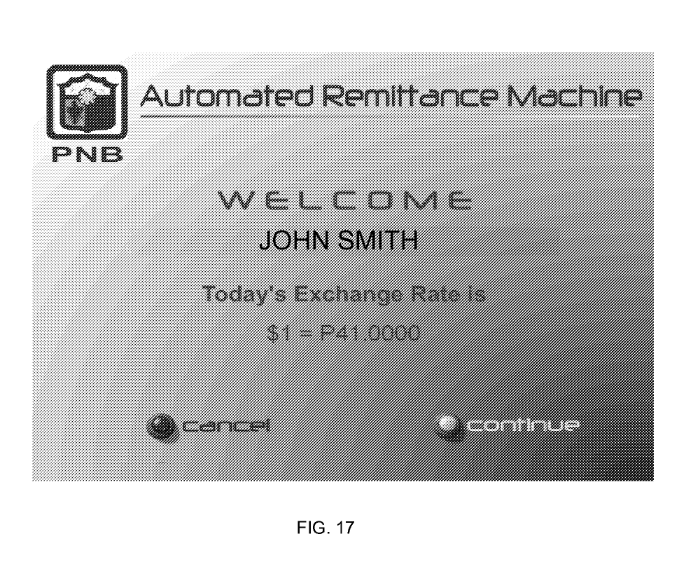

In contrast, if it is determined that the remitter's card is not valid, is locked, or is blacklisted the system moves to step 490 and the login process is cancelled. In one embodiment, an error message may be provided to the user to notify the user of the failed login attempt. In one embodiment, the notification message may be specific so that the user is notified about the specific reasons for the failure to log in to the system. In one or more embodiment, in step 480, if the remitter has been signed on for the first time, the remitter will be presented with a terms and conditions screen (an embodiment of which is depicted in FIG. 16) with an “I AGREE” and “I DO NOT AGREE” buttons. In one embodiment, if the remitter chooses the “I AGREE” button, then any subsequent sign on will redirect the remitter straight to the welcome screen (an embodiment of which is depicted in FIG. 17). In some embodiments, if the remitter decides to choose the “I DO NOT AGREE” button, then the remitter will be signed out of the remittance kiosks and the terms and conditions screen will be displayed again in any subsequent sign in until the remitter has chosen the “I AGREE BUTTON.” In another embodiment, the terms and conditions screen is displayed every time the remitter signs on to the ARM regardless of whether the remitter accepts the terms and conditions and whether it is the first time the remitter has signed onto a remittance kiosk.

In some embodiments, after the remitter is signed on to the remittance kiosk the remitter is presented with a welcome screen, for example as illustrated in FIG. 17. In one embodiment, the welcome screen may comprise an informational page that greets the remitter and may further include information such as the exchange rate for the day, a link to the transaction page, etc.

FIG. 5A illustrates a process 500a of client interaction with the remittance kiosk in accordance with one embodiment of the present invention. In one embodiment, the remittance kiosk or ARM is located in a public location such as a hospital, supermarket, on board of a ship, or at remittance center or branch locations and is accessible at any hour. In one embodiment, the kiosks may be placed in communities having a high population of residents of certain ethnicity or race, for example, Filipinos. In another embodiment, the kiosks can be placed in communities where there are no branches.

First, in step 510, the remitter requests a remittance transaction and enters transaction or remittance information such as the beneficiary, a method of payment, for example, credit or debit card, cash, etc., a security code for the method of payment (if applicable), the remittance amount, etc., and submits the information to the ARM.

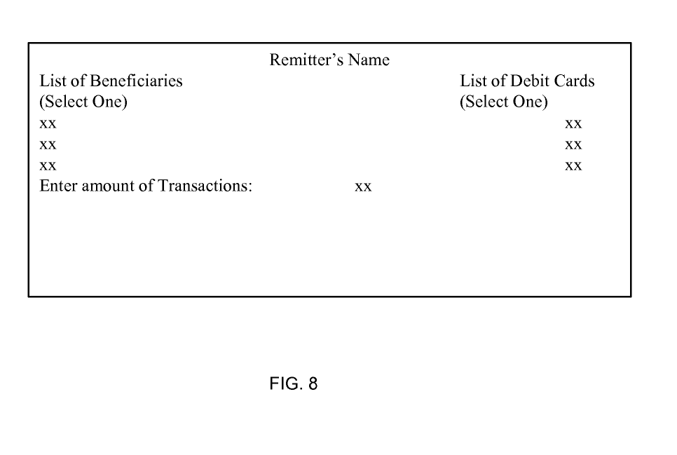

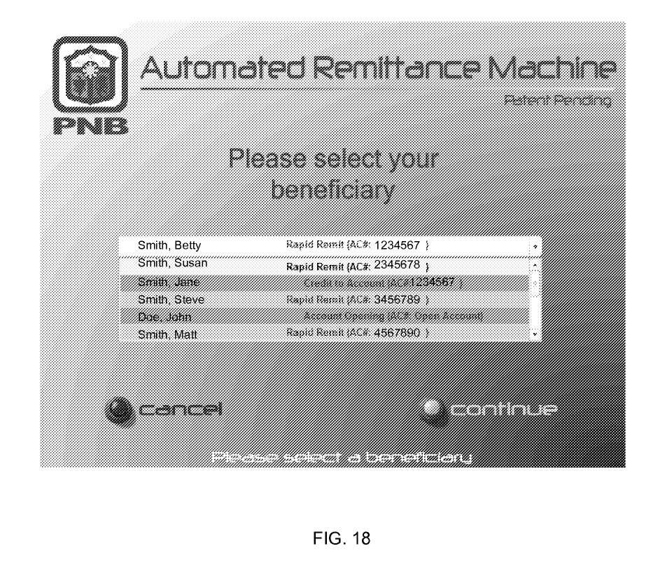

In one embodiment, after logging into the system, the remitter is presented with the transaction screen to complete a transaction. For example, as described above, in one embodiment upon successful login to the system, the welcome screen provides the remitter with a link to the transaction screen and the remitter clicks the link. FIG. 8 illustrates an exemplary embodiment of the transaction screen according to one or more embodiments. In some embodiments, the transaction may be completed through a series of one or more screens such as the screens shown in FIGS. 18-25 discussed below, the collection of these screens are referred to herein as “transaction screen”. In one embodiment, the transaction screen provides the remitter with items such as, a list of the enrolled beneficiaries associated with the remitter and information related to the beneficiaries, wherein the remitter is able to choose the beneficiary he/she wishes to send money to. In a further embodiment, the transaction screen also provides a list of possible transactions that the remitter may select, and/or a drop down list of different forms of payment that the remitter may select from. In a further embodiment, the transaction screen may also provide an input field for the remittance amount, and/or an input field for PIN/security code for the form of payment. Further, in some embodiments, the transaction screen may display information such as the amount of charges applicable, exchange rates for the day, a total amount field displaying the remittance amount and the charges combined, and a text field for displaying the transaction result of the Remitter's transaction. The transaction screen may further provide a continue button, clear button and/or a sign out button.

Returning to FIG. 5A, in step 512, the remittance/transaction information is sent from the ARM to the Remittance Kiosk Server. In one embodiment, the Remittance Kiosk Server is located at the corporate office and the ARM sends the information directly to the corporate office. In another embodiment, the information may be sent to the Remittance Kiosk Server through a branch.

Next in step 514, the transaction information is used to process the transaction. FIG. 5B illustrates an exemplary process 500b for processing the transaction at the server. After the transaction is processed, in step 516 the ARM receives the transaction status information. In one embodiment, the process then continues to step 518 and the transaction status information is displayed to the user.

As stated above, FIG. 5B illustrates a process 500b for processing a transaction at the server according to one embodiment. In step 530, the transaction request information is received at a central office, such as the corporate office. In one embodiment, for example, the information is forwarded from the ARM to the kiosk server at the corporate office. In other embodiments, the information may be forwarded to another entity in the corporate office and forwarded to a server for processing. In step 532, the kiosk server determines whether the transaction requires clearance. Clearance may be required for certain accounts having an indication of OFAC issues. In one embodiment, for example, certain transactions are marked with OFAC findings as described in FIG. 4 above. In another embodiment, the system may have settings indicating that certain transactions require clearance before being processed. In one embodiment, if it is determined that clearance is required, the transaction information (or some part of it) is forwarded from the server to the COMPLIANCE department for clearance, in step 534. Upon receiving the transaction, the Compliance manager/representative (COMPLIANCE) reviews the transaction and determines if the remitter and or beneficiary of the transaction have OFAC issues, in step 536. In one embodiment if it is determined that there is an OFAC issue, the process continues to step 546 and the transaction is cancelled. An error message may be sent to the remittance kiosk to be displayed to the user.

On the other hand, if in step 536 it is determined that the transaction is clear, i.e., there are no OFAC issues, the process moves to step 538. In step 538, the information is forwarded to the branch server. For example, the kiosk server may forward the information to the branch server. In some embodiments, the kiosk server will determine the regional branch server that is assigned to the ARM and is handling the transaction and will forward the information to the respective branch server. Similarly, if in step 532 it is determined that clearance is not required, the process moves to step 538. In some embodiments, the kiosk server determines which of the regional branch servers, e.g., west, east, central branch servers, handles the ARM from which the information was received and forwards the information to that branch server. In one embodiment, the remittance kiosk server has access to information regarding the ARM and determines the respective branch server of the ARM based on the information.

In some embodiments, the information may be saved locally at the Corporate Office. In other embodiments, the information may be stored remotely at a different location in communication with the corporate office, and the kiosk server will access the remote database to obtain the information. In one embodiment, for example, the kiosk information comprises the identity of the ARM's respective branch server. In another embodiment, the kiosk information comprises the geographical location of the kiosk and it is determined which host handles the kiosk in that geographic area.

Next, in step 540, the branch server determines whether approval of the transaction is required before the transaction can be processed. In one embodiment for example, the server determines whether approval is required based on the validation status of the transaction. In another embodiment, system settings may indicate certain transactions as requiring approval. In some embodiments, all transactions will require approval, while in other embodiments, only some transactions require approval. For example, in one embodiment online transactions, i.e., transactions in which the beneficiary has an account with the bank from which the remittance is being made do not require approval, while non-online transactions, i.e. those with a beneficiary without an account with the bank will require approval. In one embodiment, while all transactions will require approval, some transactions will be auto approved by the system, while others will have to be sent to the branch for approval.

If it is determined that approval is required, in step 538, the server sends some or all of the transaction information to the branch for approval. In one embodiment, after receiving the transaction information at the branch the transaction is approved by a supervisor at the branch. In some embodiments, auto approval is completed at the branch server. That is, in some embodiments, the information is not sent to a branch and the branch server and may automatically perform the approval.

Next, in step 544, it is determined, if the transaction is approved. In one embodiment, if the transaction is not approved, through auto approval, by the supervisor at the branch or otherwise, the process continues to step 546, where the transaction is cancelled and an error message may be sent to the remittance kiosk to be displayed to the user.

If, on the other hand, the transaction is approved by the supervisor or automatically approved by the branch server, or approved by any other means, the process moves to step 548 and the transaction information, comprising the information necessary for processing the remittance transaction, is forwarded to the head office for processing and posting. In some embodiments, some or all of the transaction information received at the corporate office is forwarded to the head office. In some embodiments, other information may also be retrieved and forwarded to the head office in addition or instead of the transaction information. Similarly, in one or more embodiments, if in step 540 it is determined that approval is not required, the transaction continues to step 540, and the transaction information is forwarded to the head office for processing and posting. In some embodiments, as described above, the branch server is in communication with the head office and will forward the information to the head office for processing and posting.

In some embodiments, the information is received at the head office at the Central Server. The central server then forwards the transaction to KBI, FLEXCUBE or GRS for processing. In some embodiments, the central server determines whether the transaction is an online or non-online transaction and will forward some or all of the transaction information to KBI, FlexCube or GRS based on this determination. In other embodiments, the central server may send the transactions to KBI, FlexCube or GRS based on some other criteria, or may choose one of these systems for all transactions. It should be noted, that in alternative embodiments the information may be received at the head office and the determination may be made by an entity other than the central server, e.g. a teller at the head office, and furthermore, the processing of the transaction may be done by means other than KBI, FlexCube or GRS. In some embodiments, after the selected system processes the kiosk transactions and the transactions are posted to their respective hosts. For example, the transaction is sent back to the branch server that forwarded the transaction information and will be saved at the branch server database. Furthermore, in some embodiments, some or all of the transaction processing information may also be stored at the central database at the head office.

Next, in step 550, a notification may be sent to the beneficiary to inform the beneficiary that the transaction has been processed and posted. For example, in one embodiment, an SMS is sent to the beneficiary from the SMS Alert System and/or the Paysetter/Globe or Wolfpac/Smart system when the transaction is processed and posted by the host. In another embodiment, the beneficiary may be alerted by an email or phone call. Thus, in some embodiments, an SMS text message, email message, or/and other electronic message, may be sent to the beneficiary informing him or her of the remittance. In one embodiment, the message may be automatically generated by the system and then automatically sent. In another embodiment, the notification message may be manually sent. For example, in embodiments where a telephone call is made to inform the beneficiary of the remittance, the telephone call may be an automated telephone call or a manual telephone call made by a human. The beneficiary or beneficiaries receive the notification, in one or more embodiments, when multiple kiosk transactions are posted.

Next in step 552, the transaction statuses are sent back to the kiosk that originally activated the transaction. In one embodiment, the transaction status may be sent to the sending servers such as the IRS branch server or the Remittance Kiosk server at the corporate office.

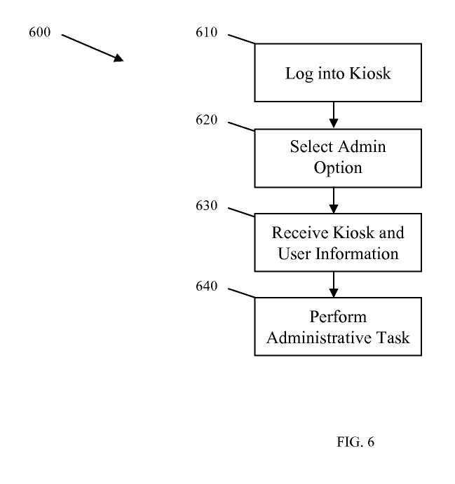

FIG. 6 illustrates a process 600 for remittance kiosk administration in accordance with one or more embodiments of the present invention.

A remittance kiosk administrator (also known as an ARM administrator) has the ability to log onto the system and access settings and other information relating to the system, remitter and or the kiosks. For example, in some embodiments, the Administrator will access the Remittance Kiosk server and individual kiosks (or individual ARMs) from a terminal.

First in step 610, the Administrator logs into the system. In one embodiment, the Administrator may log onto the system using a username and password.

Upon logging in, in some embodiments, the administrator is able to view the current settings, current remitters, or the kiosks of the Remittance Kiosk system. In one embodiment, once the settings or users page is loaded, the remittance kiosk administrator may view or update the settings, view, add, or delete kiosks, or view, add, edit, or delete remitters and/or beneficiaries from the remittance kiosk system. In one embodiment, upon logging in the administrator may be presented with a setting or user screen and may be able to select actions to perform. In step 620, the Administrator selects an Administrative task to be completed. For example, the administrator may select to view or update the settings, view, add, or delete kiosks, or view, add, edit, or delete remitters from the remittance kiosk system. Next, in step 630, the administrator receives System, Kiosk and/or Remitter information that is needed for the administrator to complete the task selected in step 620. Next, in step 640, the administrator completes the selected task. For example, in one embodiment, the administrator may view or update the settings, view, add, or delete kiosks, or view, add, edit, or delete remitters and/or beneficiaries from the remittance kiosk system.

In one embodiment, the settings may comprise a Global Remittance Amount Limit Per Day per card type and issuer, add-on changes per card type and issuer, promotional changes, the specific branch details (contact person/number, address), approval process flows/rules for OFAC findings (which role/user to clear transactions and how much), or the approval process flow/rules for normal transactions.

In one embodiment, the remitter settings may comprise information for the maintenance of system remitters. For example, information may comprise username, first name, last name, email, branch, role, password failed attempts, password reset, enable/disable user, or delete user.

In one embodiment, the kiosk settings may comprise information about the kiosk. For example, the kiosk setting may include information such as kiosk name, address of the kiosk, region, contact person, contact number, kiosk IP address, MAC address, ping access time, enable/disable kiosk function or delete kiosk from the remittance kiosk system.

It should be appreciated that the above system settings, remitter settings, and kiosk settings are just a few examples of the functions that the remittance kiosk administrator may view and/or edit.

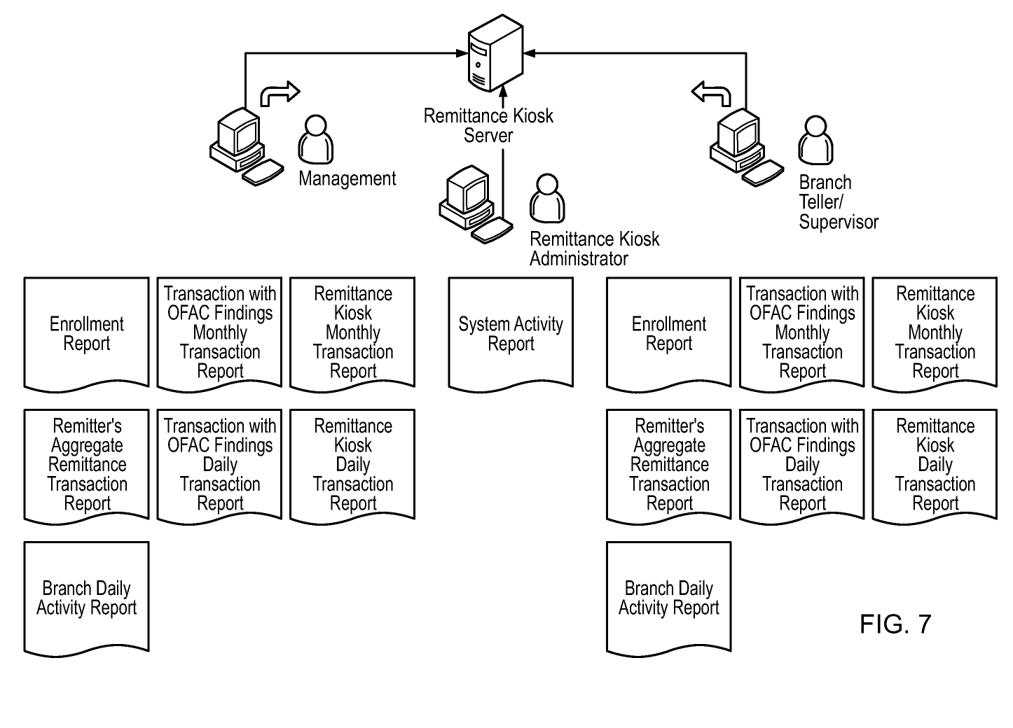

FIG. 7 illustrates various reports generated by the automated remittance system in accordance with one embodiment of the present invention. FIG. 7 outlines a plurality of the types of reports which the management, branch teller/supervisor, and/or the remittance kiosk administrator may have access to in one or more embodiments. In other embodiments, additional reports may be available to the management, branch teller/supervisor, and the remittance kiosk. In one embodiment, the Management user and Branch users have access to all reports. In another embodiment, the Management user and Branch users do not have access to the System Activity Report and the Remittance Kiosk administrator is the only person with access to this report.

In one embodiment, the remittance system may generate a remittance kiosk daily transaction report. The remittance kiosk daily transaction report is generated from information available at the remittance kiosk database. The daily transaction report includes information such as the Branch or Kiosk location and/or date and time. Furthermore, the daily transaction report may provide the reference number, remitter name, beneficiary name, product code, implementation type, purpose, remittance amount, and charges for each transaction completed at one or more branches or kiosks. Furthermore, the transaction report may include the net remittance amount. In some embodiments, the remittance amount, charges and/or net remittance amount may be provided in several different currencies. In some embodiments, the daily transaction report may be generated for a certain period. For example, the report may be filtered based on a start and end date. In another embodiment, the report may be filtered by branch or kiosk location such that the report reflects the transactions completed at a particular branch or kiosk. In yet another embodiment, the report may be filtered by product code. For example, in one embodiment, the report may reflect all of the transactions involving a certain product completed at one/or more branch or kiosks. Furthermore, the report may only include transactions of a particular implementation type. In yet another embodiment, the report may include all transactions of a particular purpose.

In one embodiment, the remittance system may generate a monthly transaction report. The monthly transaction report includes information such as the branch or kiosk location, total remittance amount, total charges, and/or total net remittance amount. The monthly transaction report can be filtered according to one or more criteria including, start and end date, branch or kiosk location, product code, implementation type, and/or purpose.

In one embodiment, the remittance system may generate an enrollment report. The enrollment report, according to some embodiments, includes information such as the branch or kiosk location, remitter ID, remitter name, remitter birthday, remitter address, remitter contact number, remitter driver's license number, remitter SSN, beneficiary ID, beneficiary name, beneficiary address and/or beneficiary contact number. In several embodiments, the report may include all or some of the information listed above. In one embodiment, the remitter and beneficiary name may include first name, last name and middle name. In one embodiment, the report is generated for a specific date range having a start and end time and/or date. For example, the report may include the information for all new enrollments to the system within a specific time. In another embodiment, the enrollment report may be generated for a specific kiosk and/or branch.

In one embodiment, the remittance system may generate a transaction with OFAC findings Daily transaction report. The transaction with OFAC findings Daily transaction report includes information such as branch or kiosk location, date and time, reference number, remitter name, beneficiary name, product code, implementation type, remittance purpose, remittance amount, charges, net remittance amount. The report may be filtered according to for example start and end date, branch or kiosk location, product code, implementation type and purpose.

In one embodiment, the remittance system may generate a transaction with OFAC findings monthly transaction report. The transaction with OFAC findings monthly transaction report includes information such as branch or kiosk location, total remittance amount, total charges, and/or total net amount. The report may be filtered according to for example start and end date, branch or kiosk location, product code, implementation type and purpose.

In one embodiment, the remittance system may generate a remitter's aggregate remittance transaction report. The remitter's aggregate remittance transaction report may include one or more information such as branch of enrolment, remitter name, total number of remittance, total amount of remittance. The report may be filtered by branch of enrollment, and/or total remittance amount. For example, in one embodiment the report may include remitters having a total remittance amount equal to or greater than a predetermined amount. In one embodiment, this amount may be entered by a user such as a branch teller/supervisor, and or Management users.

In one embodiment, the remittance system may generate a branch daily activity report. The branch daily activity report includes information such as the date and time, branch, user ID, action, remitter ID, and beneficiary ID. In one or more embodiments, the action field may correspond to actions such as Login, Logout, Add CIF, Update CIF, Blacklist CIF, Override Global Remittance Amount Limit, etc. In one embodiment, the Remitter ID field is provided where one or more remitters were added or modified. In another embodiment, the Beneficiary ID field is provided where one or more beneficiaries were added or modified. In an alternate embodiment one or both the remitter ID field and beneficiary ID field may be provided as blank fields when it is determined that remitters and beneficiaries were not added or modified. In one embodiment, the report is generated for a specific date range. In another embodiment, the report may be printed for a specific field. In yet another embodiment, the report may be generated for a specific set of one or more actions listed above.

In one embodiment, the remittance system may generate a system activity report. The system activity report includes information such as date and time, event and event type. The report may be filtered using a range or event type (normal, error).

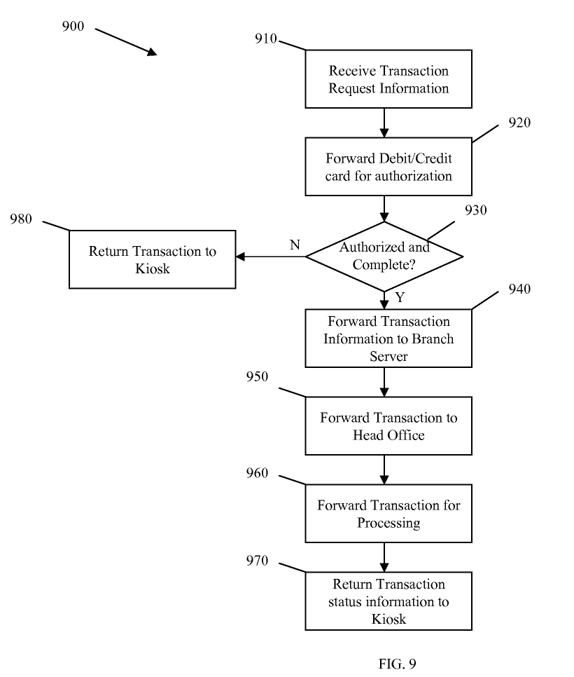

FIG. 9 illustrates a process 900 for performing transactions according to one or more embodiments, wherein in some embodiments the transaction is an online transaction. That is the transaction involves the remittance of funds to a beneficiary having an account with the bank from which the remittance is being made, e.g. Philippine National Bank (PNB). In another embodiment, online transactions may also be any transactions for which the system has updated information available.

The process begins in step 910 where the remitter enters transaction information. In one embodiment, for example, the remitter enters transaction information at the transaction screen, as depicted for example in FIG. 8. In some embodiments, the transaction may be completed through a series of one or more screens such as the screens shown in FIGS. 18-25, the collection of these screens are referred to herein as “transaction screen”.

Next, in step 920, the kiosk forwards the payment information, e.g. credit or debit number, for authorization (if applicable). In one embodiment, when the remitter chooses to pay with a debit or credit card, information regarding the remitter's account tied to the user membership card (GFC) along with the account number of the debit or credit card is sent to an online payment gateway. The online payment gateway accesses a database of banks and other financial institutions and returns the result of the payment authorization. The results may be in may different forms such as a message containing a response code, text, a numerical value, etc. In one embodiment, for example, a response code regarding the validity of the payment is received. For example, the response code could return that the name on the debit or credit card matches the name associated with the user membership card and that the payment is accepted. On the other hand, the response code could return that the names do not match each other, and the payment is not accepted. The system uses these response codes to determine whether the transaction is valid. When the remitter chooses to pay with cash, the ARM validates the transaction by checking the imprint or image of each bill (or cash note) loaded into the ARM. In some embodiments, the ARM includes a cash or currency reader, which reads the image of each bill or cash note loaded into the ARM. If the amount of cash scanned is equal to the payment amount, then the transaction is valid.

In step 930, if it is determined that the debit/credit card is not authorized and or the information is not complete the process continues to step 980 where the information is returned to the kiosk and the transaction may be canceled. In one embodiment, the kiosk may issue a message to the remitter. In an alternative embodiment, upon receiving the returned transaction data the kiosk may issue a request for additional information and resubmit the request for the transaction.

On the other hand, if in step 930 it is determined, that the payment information is complete the process continues onto step 940 where the information is forwarded to the branch server for the specific kiosk. For example, the branch server may be the west, east, central or other server depending on the geographical location of the kiosk. FIG. 11 illustrates the grouping of kiosks and servers in accordance with one embodiments of the present invention. As shown in FIG. 11 the kiosks are grouped based on geographical location. In another embodiment, the branch servers might be assigned to kiosks according to criteria other than geographical location.

After being received at the branch server, the transaction information is forwarded to the Head Office, in step 950. In some embodiments, only a portion of the remittance or transaction information is sent to the head office. In some embodiments, the transaction information may be supplemented with other information before being sent to the head office. At the Head office, the information may be received by the IRS Central server. Then, in step 960, in some embodiments, some or all of the information is sent to KBI or FLEXCUBE to be processed. It should be noted, that these are exemplary processing systems and any other processing system may be used. After the transaction has been processed, in step 970, the transaction status information is returned to the Kiosk.

In one embodiment, the transaction status information may be returned in the same way it was received while in other embodiments the information may be returned using an alternative route. In one exemplary embodiment, the KBI or FLEXCUBE sends the status information to the IRS Central server, which then forwards the information to the Branch Server associated with the kiosk that requested the transaction. Next, the branch server forwards the transaction status information to the Kiosk either directly or through the kiosk server. In one embodiment, upon receiving the transaction status information the Kiosk will display the information to the remitter.

In one or more embodiments, upon processing the transaction the host and/or the central server may issue a notification to the beneficiary to notify them of the status of the transaction. In some embodiments, at one or more stages of the process, additional information needed for processing the information may be retrieved at the branch server or the IRS central server and will be sent to the KBI or FLEXCUBE along with the remittance or transaction information entered at the kiosk. In one embodiment, after the transaction is completed information regarding the transaction may be stored at one or more of the central server and/or branch server and or other database or servers at the corporate office, the head office, or any branch, or at a remote location, for later retrieval. For example, in one embodiment, the information may be stored for monitoring purposes and may be retrieved as reports at a later time by tellers/supervisors or other users of the system.

Online transactions, according to some embodiments, will be posted real-time. In one or more embodiments, the online transactions will be posted in real time when the branch server is online and otherwise may be held for approval by the supervisor from the branch or Head Office.

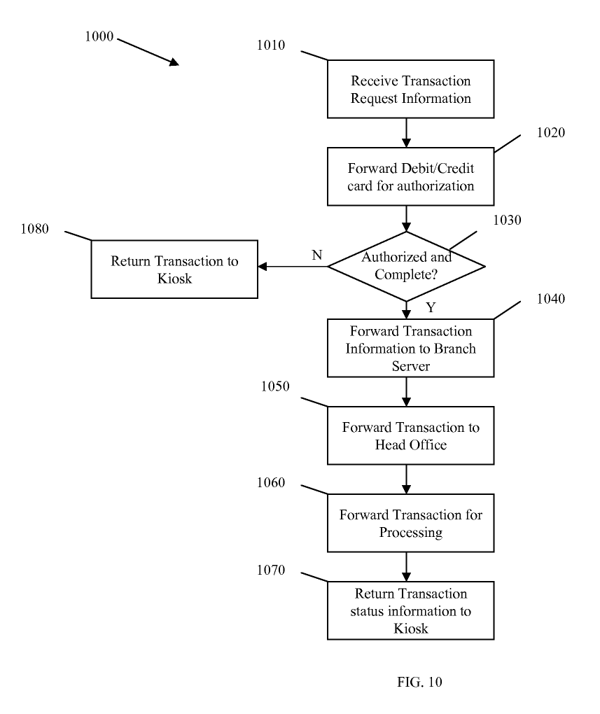

FIG. 10 illustrates an alternative process 1000 for processing transactions according to one or more embodiments, wherein in some embodiments the transaction is a non-online transaction. That is the transaction involves the remittance of funds to a beneficiary that does not have an account with the bank from which the remittance is being made, e.g. Philippine National Bank (PNB). In another embodiment, online transactions may also be any transactions for which the system does not have updated information available.

The process begins in step 1010 where the remitter enters transaction information. In one embodiment, for example, the remitter enters transaction information at the transaction screen, as depicted for example in FIG. 8. In some embodiments, the transaction may be completed through a series of one or more screens such as the screens shown in FIGS. 18-25, the collection of these screens are referred to herein as “transaction screen”.

Next, in step 1020, the kiosk forwards the payment information, e.g. credit or debit number, for authorization (if applicable). In one embodiment, when the remitter chooses to pay with a debit or credit card, information regarding the remitter's account tied to the user membership card (GFC) along with the account number of the debit or credit card is sent to a payment gateway. The payment gateway accesses a database of banks and other financial institutions and returns the result of the payment authorization. The results may be in many different forms such as a message containing a response code, text, a numerical value, etc. In one embodiment, for example, a response code regarding the validity of the payment may be received. For example, the response code could return that the name on the debit or credit card account matches the name associated with the user membership card and that the payment is accepted. On the other hand, the response code could return that the names do not match each other, and the payment is not accepted. The ARM uses these response codes to determine whether the transaction is valid. When the remitter chooses to pay with cash, the ARM may validate the transaction by checking the imprint or image of each bill (or cash note) loaded into the ARM. In some embodiments, the ARM includes a cash or currency reader, which reads the image of each bill or cash note loaded into the ARM. If the amount of cash scanned is equal to the payment amount, then the transaction is valid.

In step 1030 if it is determined that the method of payment is not authorized and or the information is not complete, the process moves to step 1080 and the information is returned to the kiosk and the transaction may be canceled. In one embodiment, the kiosk may issue a message to the user. In alternative embodiments, upon receiving the returned transaction data the kiosk may issue a request for additional information and resubmit the request for the transaction.

On the other hand, if in step 1030 it is determined, that the payment information is complete and the payment is authorized, the process continues onto step 1040 where the information is forwarded to the branch server associated with the specific kiosk. For example, the branch server may be the west, east, central or other server depending on the geographical location of the kiosk. FIG. 11 illustrates the grouping of kiosks and servers in accordance with one embodiments of the present invention. As shown in FIG. 11 the kiosks are grouped based on geographical location. In another embodiment, the branch servers might be assigned to kiosks according to criteria other than geographical location.

After being received at the branch server, the transaction information necessary for processing the remittance requested at the kiosk is forwarded to the Head Office in step 1050. In one or more embodiments, the information forwarded to the head office comprises some or all of the remittance/transaction information. In some embodiments, additional information may also be sent to the head office. At the Head Office, the information may be received by the Central Server. In some embodiments, non-online transactions may be held for approval by the supervisor. In step 1060, after approval the transactions may be sent to the GRS for processing. In other embodiments, the processing of transactions may be done through different entities such as the teller, etc. After the processing of the transaction is completed, in step 1070, the transaction status information is returned to the Kiosk either directly or through the kiosk server. In one embodiment, the transaction status information may be returned in the same way it was received while in other embodiments, the transaction status information may be sent to the kiosk through one or more different routes. In one exemplary embodiment, the IRS Central server forwards the information to the Branch Server associated with the kiosk that requested the transaction. Next, the branch server forwards the transaction status information to the Kiosk either directly or through the remittance kiosk server. In one embodiment, upon receiving the transaction status information the Kiosk will display the information to the remitter. In one or more embodiments, upon processing the transaction the system may issue a notification to the beneficiary to notify them of the status of the transaction. In some embodiments, at one or more stages of the process additional information needed for processing the information may be retrieved at the branch server or the IRS central server. In one embodiment, after the transaction is completed information regarding the transaction may be stored at one or more of the hosts, central server and/or branch server for later retrieval. For example, in one embodiment, the information may be stored for monitoring purposes and may be retrieved as reports at a later time by tellers/supervisors or other users of the system.

Referring next to FIG. 12, a touch screen computer utilized as the ARM, in one or more embodiments, is illustrated in accordance with one embodiment of the present invention. In one or more embodiments, the kiosk comprises a touch screen computer device. In one embodiment, the kiosk has a card swipe device attached thereto. The touch screen computer comprises a touch screen LCD display along with a card reader. Instructions are displayed to the user through the touch screen LCD display and the user may input their selections by touching the LCD screen. In another embodiment, the user may also use a mouse or keyboard to input his or her selections. For example, in some embodiments, the display screen of the ARM may not be touch screen, and the user inputs information through a keyboard/mouse system.

Referring next to FIG. 13, a receipt printer that may be utilized with the touch screen computer to comprise the ARM is illustrated in accordance with one embodiment of the present invention.

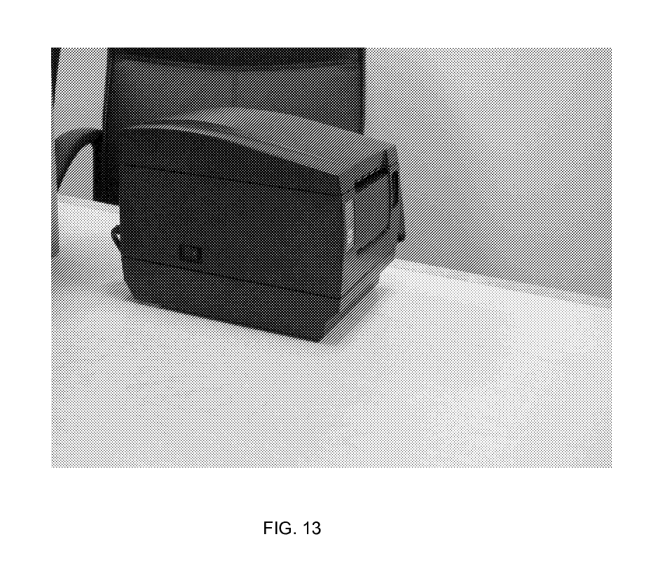

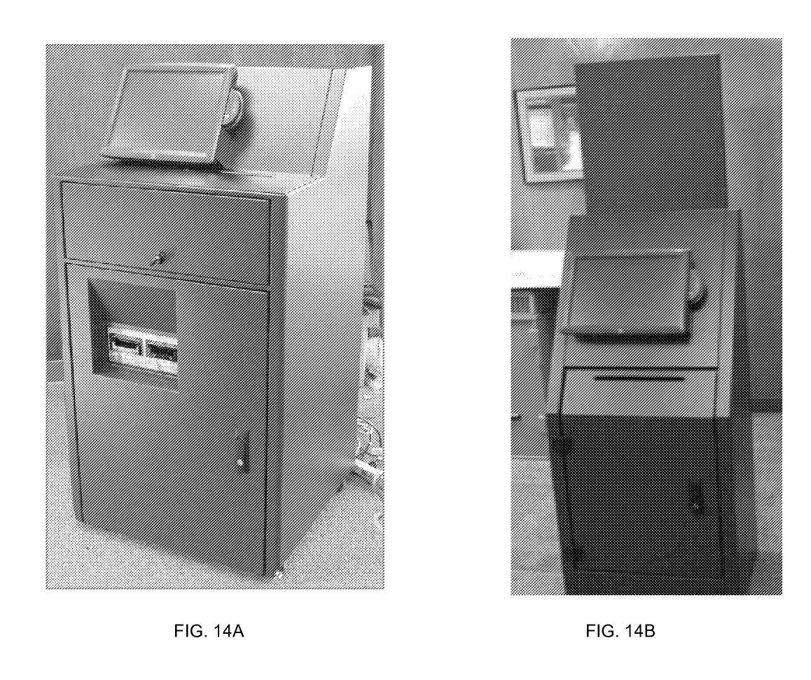

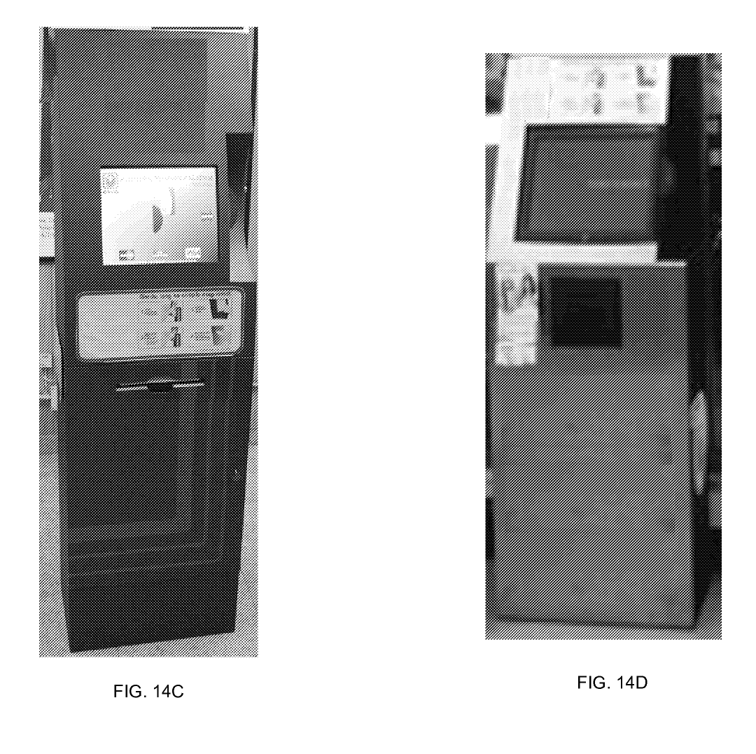

Referring next to FIGS. 14A, 14B, 14C and 14D, stand-alone kiosks that provide the housing of the ARM are illustrated. These kiosks are placed in public areas to allow a customer/client/remitter access to the ARM at all hours of the day. Since these kiosks are located in public places, a remitter is not restricted to the business hours of a financial institution to conduct remittance transactions. In addition, placing kiosks in areas frequently visited by remittance customers provides an additional convenience. Customers would have the ability to perform remittance transactions in the same location as everyday tasks. Locations could include hospitals, supermarkets, restaurants, etc. FIG. 14A illustrates an ARM having a cash vault, while FIG. 14B illustrates an ARM without a cash vault.

The Automated Remittance Machine (ARM) is designed to empower the ARM's remitters to remit on their own avoiding long queues and, even if the branch is closed. The ARM can accept debit cards and credit cards. In addition, the ARM may accept cash as well. Further embodiments of the Automated Remittance System includes online tutorial of ARM, online enrollment of a user membership card (for example, the Global Filipino Card (GFC)) using either the touchpad LCD or a keyboard/mouse system for registering user inputs, loading a user membership card (such as the GFC), providing remittance transaction inquiry at the ARM, allowing payment of utilities or other payables for beneficiaries in another country from the ARM, and providing user membership card (such as the GFC) reward points inquiry.

FIGS. 15-26 illustrate examples of different screens that may be displayed on the display screen of the ARM to a remitter utilizing the ARM. Buttons/selections disposed on the following screens may be selected through the use of a touch pad LCD or alternatively through the use of a keyboard/mouse or other input device. Additional user inputs may be registered to the ARM through the use of a touch pad LCD or through the use of a keyboard/mouse or other input device.

Referring to FIG. 15, a sign-on screen is illustrated which prompts a remitter to swipe a user membership card (Global Remittance Card), such as the Global Filipino Card, in accordance with one embodiment of the present invention. Typically, the sign-on screen may be the first screen shown to a remitter. However, it should be understood that this may not necessarily be the case. For this embodiment, the sign-on screen provides instructions to swipe the Global Remittance Card, e.g. Global Filipino Card, at the bottom of the sign-on screen to initiate a transaction. A photo exemplifying a card reader with a Global Filipino Card is disposed at the center of the screen, along with an arrow indicating the location of the card reader. In addition, the logo of the financial institution may be disposed at the topmost portion of the sign-on screen. In some embodiments, the logo of the financial institution is disposed within every screen displayed in the ARM. The remitter swipes his/her remittance card, e.g., Global Filipino Card (GFC), on the magnetic card reader found on the side of the machine for the validation and entry into the remittance kiosk/automated remittance machine. In another embodiment, a remitter/user may gain entry into the ARM through entering a username/password. The username/password may be entered utilizing a touch screen. Alternatively, a keyboard/mouse is utilized to allow the remitter to input a username/password. In one embodiment, the sign-on screen may be the first screen the remitter sees when he/she uses the ARM. In one embodiment, after being presented with this window the client swipes his or her card to advance to the next screen. In other embodiments, the card information may be entered through other means. In yet another embodiment, the user may advance to the next window by entering a user name or password, scanning the card, etc. In one embodiment, the remitter may advance to the next screen after the remitter card is validated.

Referring to FIG. 16, a terms of service screen is illustrated which displays the terms of service for the ARM in accordance with one embodiment of the present invention. Navigation arrows are disposed to the side of the screen, the use of the navigation arrows allows a remitter to scroll through the text of the terms of service. A check box for agreeing with the terms of service is disposed towards the bottom of the screen. When the remitter touches the check box, an indication of a checkmark may appear indicating agreement of the terms of service. In addition, cancel and continue buttons are disposed at the bottom of the screen. Choosing the cancel button would terminate the transaction while choosing the continue button sends the remitter to the next screen. In one embodiment, if the remitter does not agree to the terms of service, the transaction is terminated (as discussed with reference to FIG. 4). In accordance to some embodiments, if the remitter is using the ARM for the first time, the Terms of Service screen is shown where the remitter is informed of the terms of usage of the ARM.

Referring to FIG. 17, a welcome screen is illustrated which displays a welcome message to the remitter/user in accordance with one embodiment of the present invention. The remitter is greeted with a welcome message and is then informed of the exchange rate for the day. In addition, cancel and continue buttons are disposed at the bottom of the screen.

Referring to FIG. 18, a beneficiary screen is illustrated which displays the list of beneficiaries for the remitter in accordance with one embodiment of the present invention. The beneficiary screen prompts the remitter to select the beneficiary of the remitted funds. The beneficiary screen includes a drop down list of beneficiaries which the remitter highlights his/her selection. Cancel and continue buttons are disposed at the bottom of the screen. In alternative embodiments, the beneficiary screen may provide the remitter with a list of beneficiaries or the intended beneficiary in alternative ways, such as search field with an auto fill option. In another emobidment, the remitter may manually enter a beneficiary instead of choosing a beneficiary from the drop down menu. The beneficiary information may be entered through a keyboard/mouse set-up, or by utilizing a touch screen which displays a keyboard. Cancel, back and continue buttons are disposed at the bottom of the screen which gives the remitter is given a choice of whether to cancel his/her transaction, navigate to the previous screen, or to continue his/her transaction.

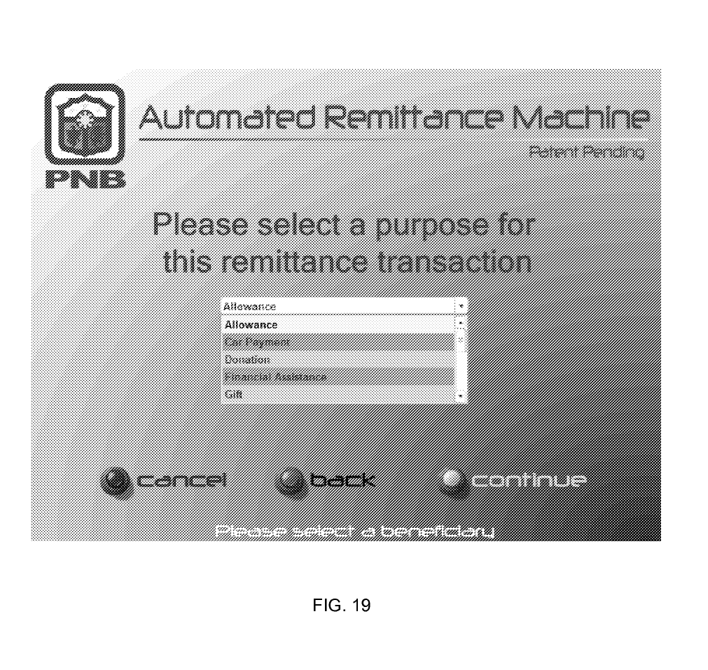

Referring to FIG. 19, an example embodiment of a remittance purpose screen is shown which prompts the user/remitter to enter the purpose of remittance. The different purposes for remittance are selected from a drop down menu disposed at the center of the remittance purpose screen. Examples of remittance purposes include allowance, car payment, donation, financial assistance, gift, house construction, house & lot payment, hospitalization, loan payment, lot payment, others, payment, savings, and tuition. It should be appreciated, however, that these are just a few examples of remittance purposes. In another emobidment, the remitter may manually enter a remittance purpose instead of choosing a purpose from the drop down menu. The remittance purpose may be entered through a keyboard/mouse set-up, or by utilizing a touch screen which displays a keyboard. Cancel, back and continue buttons are disposed at the bottom of the screen which gives the remitter is given a choice of whether to cancel his/her transaction, navigate to the previous screen, or to continue his/her transaction.

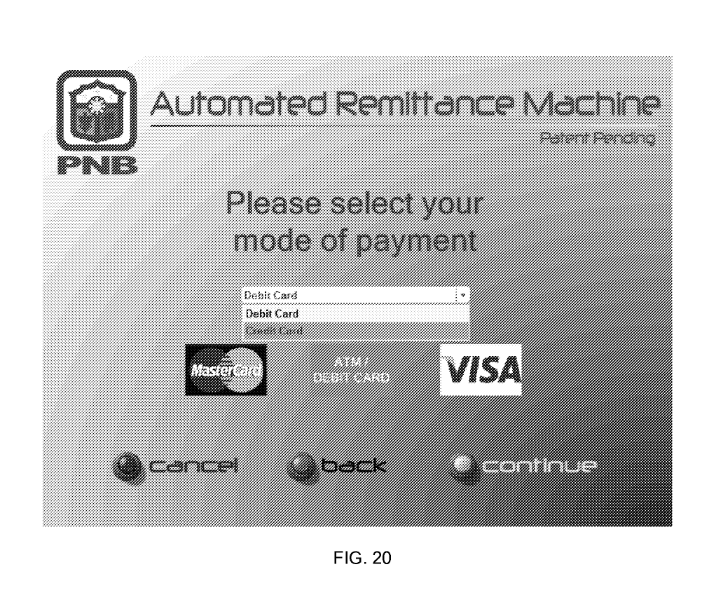

Referring next to FIG. 20, an example embodiment of a mode of payment screen is shown which displays the different modes of payment that the remitter may choose to pay for his/her transmitted funds. The mode of payment screen is shown to the remitter for him/her to choose where the remittance funds will come from. The remitter can choose the form of payment from the drop down menu disposed at the center of the mode of payment screen. Although, in this figure the only options are either Debit Card or Credit Card, other forms of payment such as cash may also be available and will be presented to the remitter. If the remitter has selected a debit or credit card, the remitter then swipes the debit or credit card through the card reader. In some embodiments, the payment may be made by cash instead of debit or credit card or through an account. If the remitter has selected cash, the remitter then feeds bills into the ARM. In such embodiments, the ARM may be outfitted with a cash or currency reader that accepts the currency.

In another embodiment, the remitter associates a specific debit or credit card with his/her user membership card (such as the Global Filipino Card). In some embodiments, by associating a debit or credit card with his/her Global Remittance Card, e.g., Global Filipino Card, the remitter foregoes swiping the debit or credit card and the ARM uses the debit/credit card associated with the user membership card as payment for the transaction. In another embodiment, the remitter associates a bank account with his/her user membership card (such as the Global Filipino Card). If the remitter selects the bank account as the mode of payment, the ARM then uses the associated bank account as payment for the transaction. Cancel, back and continue buttons are disposed at the bottom of the screen that allow the remitter to cancel his/her transaction, navigate to the previous screen, or to continue his/her transaction.

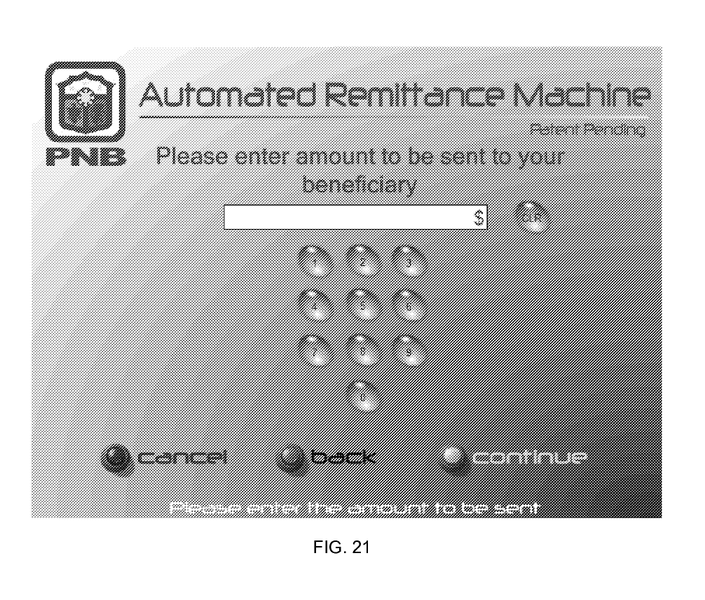

Referring to FIG. 21, an example embodiment of a transfer amount screen is shown which displays a numeric pad, which allows the user to enter the amount of funds to send to the selected beneficiary. The remitter is able to select the amount he/she wishes to transfer to the selected beneficiary. In some embodiments, there may be limits to the amount that can be sent depending on the mode of payment selected from the mode of payment screen. The remitter may enter the amount by choosing the buttons on the numeric pad by depressing the numeric buttons. In another embodiment, the remitter uses a keyboard/mouse configuration to enter the amount of funds to remit. Cancel, back and continue buttons are disposed at the bottom of the screen to allow the remitter to cancel his/her transaction, navigate to the previous screen, or to continue his/her transaction.

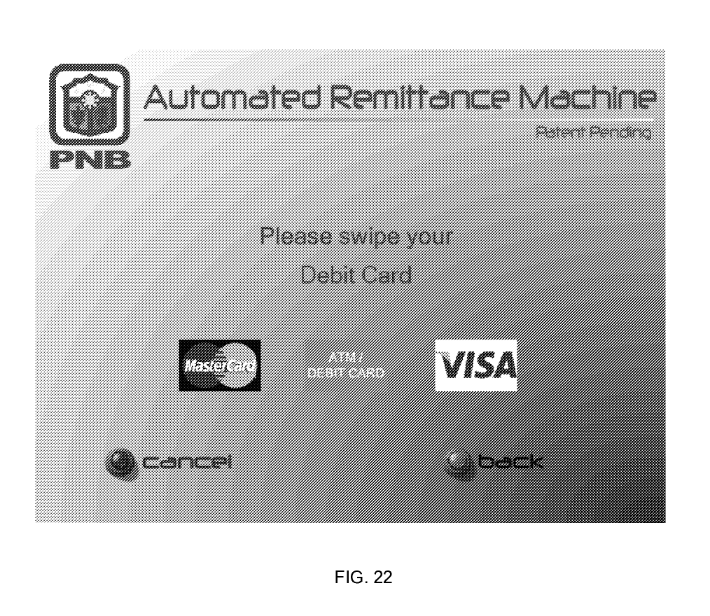

Referring to FIG. 22, an example embodiment of a swipe card screen is shown. In one embodiment, the swipe card screen may only appear if the remitter chooses credit or debit card as his mode of payment. The screen prompts the remitter to enter his/her debit or credit card. Cancel and back buttons are disposed at the bottom of the screen to allow the remitter to cancel his/her transaction, navigate to the previous screen, or to continue his/her transaction. When the remitter swipes their debit or credit card the screen moves forward and the transaction continues. In an alternative embodiment, a continue button may also be provided (not shown). In an alternative embodiment, where cash is used, a screen having directions for inserting cash may be displayed to the user in lieu of the swipe debit/credit screen.

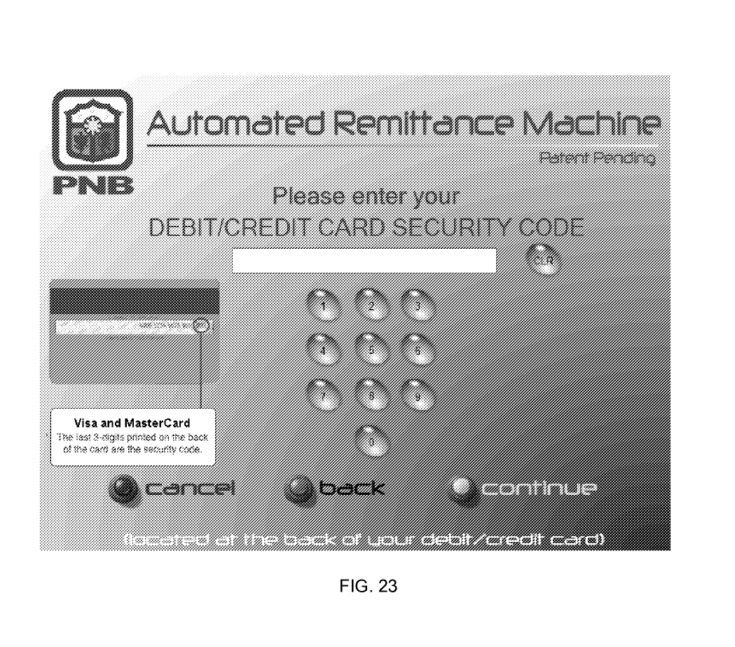

Referring to FIG. 23, an example embodiment of a Debit/Credit security code screen is illustrated. The remitter is asked to enter his/her security code when the remitter uses a debit or credit card. The remitter is provided with a numerical key pad to enter the security code. Cancel, back and continue buttons are disposed at the bottom of the screen to allow the remitter to cancel his/her transaction, navigate to the previous screen, or to continue his/her transaction. In an alternative or additional embodiment, the remitter may be presented with a debit PIN code screen which prompts the user/remitter for the debit card PIN code. In such embodiments, when the remitter selects debit card as the mode of payment in the mode of payment screen, the remitter may then be asked for his/her PIN code or Security code to verify the use of the debit card. The remitter enters the PIN or security code by choosing the buttons on the numeric pad by either depressing the numeric buttons. In another embodiment, the remitter uses a keyboard/mouse configuration to enter the PIN or security code.

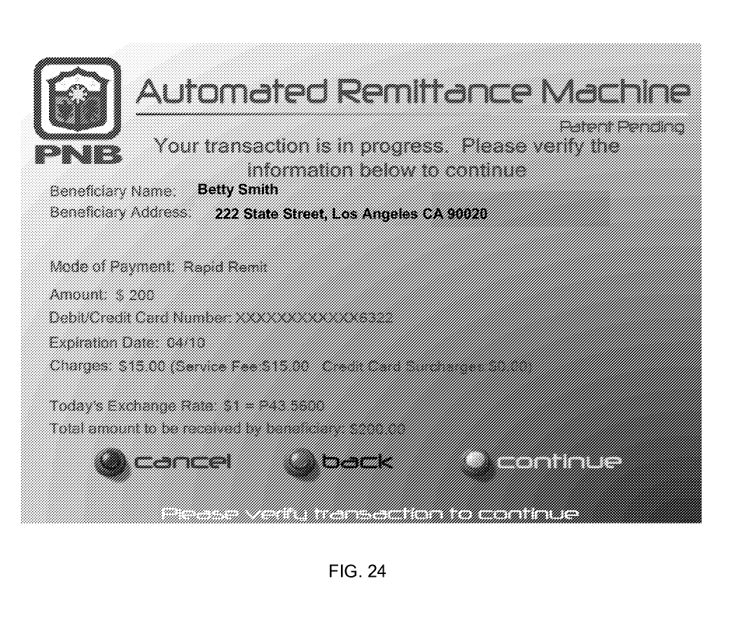

Referring to FIG. 24, an example embodiment of a transaction preview screen is shown which displays a summary of the transaction to the remitter. In some embodiments, once all inputs from the previous screens are completed, the remitter is presented with the details of his/her transaction before submitting the transaction. The remitter can double-check whether the inputs are valid or not. The transaction preview screen illustrates details such as the mode of payment, amount of funds to remit, additional fees or charges, e.g. a surcharge for using a credit card, service fee, etc., exchange rate, and the amount the beneficiary will receive (in either the currency of the country which the remitter is currently residing and/or in the currency of the country which the beneficiary is currently residing). Cancel, back and continue buttons are disposed at the bottom of the screen to allow the remitter is given a choice of whether to cancel his/her transaction, navigate to the previous screen, or to continue his/her transaction.

Once the remitter has decided to continue with the transaction, the automated remittance system proceeds to verify the transaction and the various inputs from the remitter (as discussed with reference to FIG. 5A). At this point, the method of payment is validated as described above. For example, in one embodiment, when the remitter chooses to pay with a debit or credit card, information regarding the remitter's account tied to the Global Remittance Card along with the account number of the debit or credit card is sent to an online payment gateway. The online payment gateway accesses a database of banks and other financial institutions and returns a response code regarding the validity of the payment. For example, the response code could return that the name on the account number of the debit or credit card matches the name associated with the user membership card and that the payment is accepted. On the other hand, the response code could return that the names do not match each other, and the payment is not accepted. The ARM uses these response codes to determine whether the transaction is valid. When the remitter chooses to pay with cash, the ARM validates the transaction by checking the imprint or image of each bill (or cash note) loaded into the ARM. In some embodiments, the ARM includes a cash or currency reader, which reads the image of each bill or cash note loaded into the ARM. If the amount of cash scanned is equal to the payment amount, then the transaction is valid.

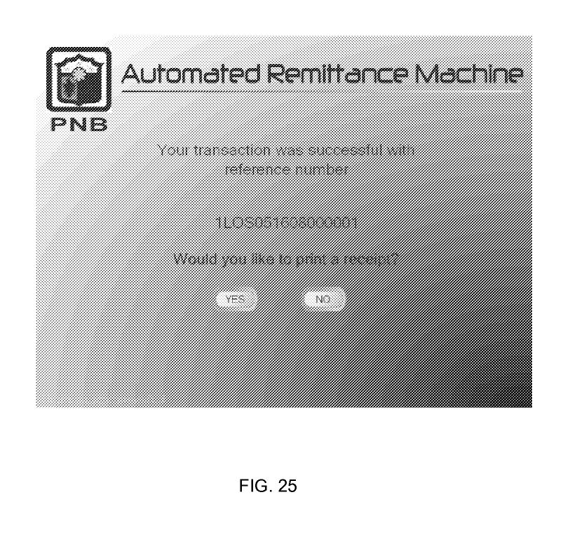

Referring to FIG. 25, an example embodiment of a transaction reference screen is shown which displays the transaction reference number to the user. In addition, the transaction reference screen alerts the user to whether or not the transaction was successful. If the transaction is successful, the remitter is presented his/her transaction reference number and a receipt printout of the transaction. If the transaction is not successful, the remitter is displayed a failed transaction message. In another embodiment, the remitter is supplied more detail regarding the failure of the transaction. For example, if the remitter fails to supply enough cash for the amount indicated, then a failure transaction message would describe the failure due to insufficient funds. In a further embodiment, the ARM supplies the remitter with more detail regarding the failure of the transaction by utilizing the returned response codes from the online payment gateway.

In addition, the transaction reference screen presents the option for the remitter to print a receipt. The remitter chooses whether or not to print a receipt by choosing the yes or no buttons by either depressing the yes or no buttons. In another embodiment, the remitter uses a keyboard/mouse configuration to choose the yes or no buttons.

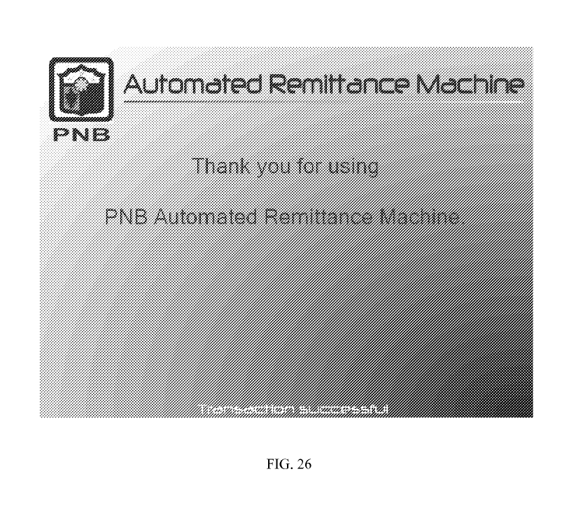

Referring to FIG. 26, an example embodiment of a thank you screen is illustrated. Once the transaction is completed, the ARM thanks the remitter for the transaction. In one embodiment, the thank you screen displays after the transaction has been successful, failed, or has been cancelled.

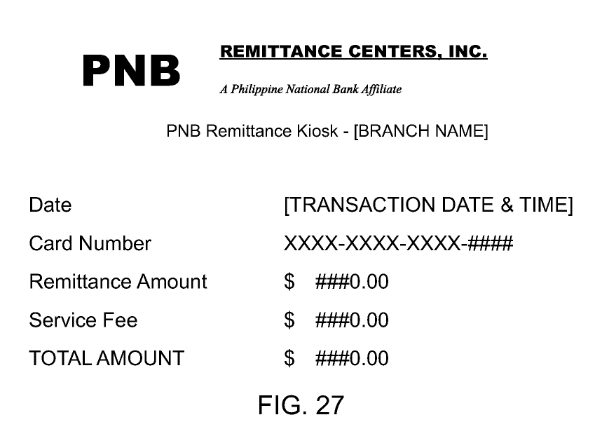

FIG. 27 illustrates an example embodiment of a receipt, which the ARM prints for the remitter. The receipt may include information that details where the ARM was located, the transaction date and time, the user membership card number, amount of payment, method of payment, service fees, and the total amount.

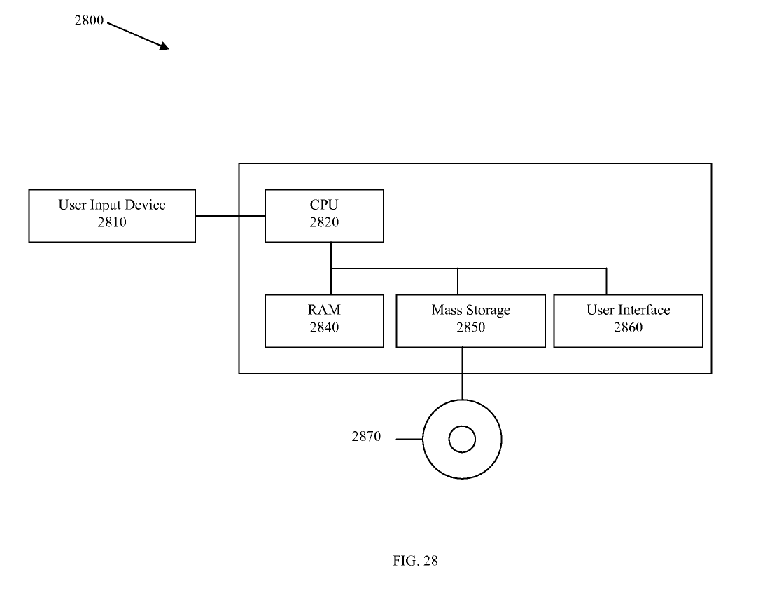

The methods and processes described herein may be utilized, implemented and/or run on many different types of systems. Referring to FIG. 28, there is illustrated a system 2800 that may be used for any such implementations. One or more components of the system 2800 may be used for implementing any system or device mentioned above, such as for example any of the above-mentioned remittance transaction processing, maintenance, enrollment and other functions of the automated remittance system, as well as the remittance kiosk, teller work stations, databases, servers, etc. However, the use of the system 2800 or any portion thereof is certainly not required.

By way of example, the system 2800 may comprise a Central Processing Unit (CPU) 2820, a Random Access Memory (RAM) 2840, a mass storage 2850, such as a disk drive, and a user interface 2860 such as a display. The CPU 2820 may be used to execute or assist in executing the steps of the methods and techniques described herein, and various content, including transaction screens may be displayed on the user interface 2860 according to several embodiments described in the present application. The system 2800 may further comprise a user input device 2810. The user input device may comprise any user input device such a keyboard, mouse, touch screen keypad or keyboard, card reader, card swipe device, etc. The system 2800 comprises an example of a device configured to execute the methods and processes described with respect to several embodiments described herein.

The mass storage unit 2850 may include or comprise any type of computer readable storage or recording medium or media. The computer readable storage or recording medium or media may be fixed in the mass storage unit 2850, or the mass storage unit 2850 may optionally include an external memory device 2870, such as a digital video disk (DVD), Blu-ray disc, compact disk (CD), USB storage device, floppy disk, RAID disk drive or other media. By way of example, the mass storage unit 2850 may comprise a disk drive, a hard disk drive, flash memory device, USB storage device, Blu-ray disc drive, DVD drive, CD drive, floppy disk drive, RAID disk drive, etc. The mass storage unit 2850 or external memory device 2870 may be used for storing code that implements the methods and techniques described herein.

Thus, external memory device 2870 may optionally be used with the mass storage unit 2850, which may be used for storing code that implements the methods and techniques described herein. However, any of the storage devices, such as the RAM 2840 or mass storage unit 2850, may be used for storing such code. For example, any of such storage devices may serve as a tangible computer storage medium for embodying a computer program for causing a computer or display device to perform the steps of any of the methods, code, and/or techniques described herein. Furthermore, any of the storage devices, such as the RAM 2840 or mass storage unit 2850, may be used for storing any needed database(s).

In one or more embodiments, the automated remittance system will provide a fully automated and innovative service using a global remittance card, such as the Global Filipino Family Card (GFFC) with all in one card and “single-swipe” enabled features in an unattended remittance counter. In one or more embodiments, the global remittance card may further function as a loyalty and discount card. In one embodiment, the system is a single swipe enable for security purpose. The customer, in one or more embodiments, may be responsible to inform the bank of any changes in his/her account information.

The above description describes functions and specifications of various embodiments of an automated remittance system. Some embodiments may include one or more of the following features such as, for example, an enrollment module from an Integrated Remittance System (IRS) to the Remittance Kiosk, a Maintenance module for the Remittance kiosk, Associating the Global Remittance Card, for example, Global Filipino Card, with a remitter CIF, Administration module for the Remittance Kiosk, A method of identification of the global remittance card, for example in one embodiment using a 3-track magnetic card reader, a Sign in process for logging into the system using the global remittance card, transaction handling with IRS for both Online and non-online transactions, OFAC/blacklist monitoring of accounts, review and clearance System for transactions, application and system logging, and remittance system transaction and activity reports.

The above description also provides various exemplary embodiments of hardware and software components integrated with and used in association with the Automated Remittance System of the present invention including, for example, touch screen integration with the ARM, 3-track magnetic card reader integration with the ARM, thermal receipt integration with the ARM, payment gateway integration with the ARM.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for use in remitting funds, comprising:
establishing a self-service apparatus in a location accessible by members of the public;
allowing unrestricted access to input/output devices of the self-service apparatus;
receiving from the self-service apparatus funds remittance information that is entered into the self-service apparatus by a user interacting with the input/output devices; and
remitting funds in accordance with the funds remittance information.

2. The method of claim 1, further comprising:
establishing membership information for users who are authorized to successfully remit funds using the self-service apparatus.

3. The method of claim 1, wherein the membership information comprises a designation of at least one beneficiary.

4. The method of claim 1, further comprising:
verifying whether a remittance of funds is authorized based on the funds remittance information entered by the user, wherein the funds remittance information further comprises a form of payment.

5. The method of claim 4, wherein the verifying comprises:
transmitting membership information for the user and at least a portion of the funds remittance information; and
receiving matching information regarding whether the membership information for the user matches owner information for the form of payment.

6. The method of claim 1, wherein the funds remittance information comprises a selected beneficiary.

7. The method of claim 1, wherein the funds remittance information comprises payment information.

8. The method of claim 1, wherein the remittance information comprises information identifying a remitter, and
wherein the user comprises the remitter.

9. The method of claim 1, wherein the remittance comprises transferring funds from a first country to a second country.

10. The method of claim 1, further comprising:
automatically sending an SMS message to a selected beneficiary informing him or her of the remittance.

11. A method for use in remitting funds, comprising:
establishing a first server that is configured to receive funds remittance information from a plurality of self-service apparatuses, wherein each of the plurality of self-service apparatuses are associated with one of a plurality of second servers;
receiving at the first server funds remittance information that was entered into a first of the plurality of self-service apparatuses;
determining which one of the plurality of second servers is associated with the first self-service apparatus;
sending at least a portion of the funds remittance information to the determined one of the plurality of second servers that is associated with the first self-service apparatus; and
remitting funds in accordance with the funds remittance information.

12. The method of claim 11, further comprising:
sending at least a portion of the funds remittance information to a third server for processing the remittance and remitting the funds.

13. The method of claim 11, further comprising:
locating each of the plurality of self-service apparatuses in a location accessible by members of the public.

14. The method of claim 11, further comprising:
allowing unrestricted access to input/output devices of each of the plurality of self-service apparatuses.

15. The method of claim 11, further comprising:
automatically sending an SMS message to a selected beneficiary informing him or her of the remittance.

16. A remittance system, comprising:
a plurality of self-service apparatuses;
a first server configured to receive remittance information from each of the plurality of self-service apparatuses; and
one or more second servers communicationally coupled to the first server, wherein each of the one or more second servers is associated with one or more of the plurality of self-service apparatuses;
wherein, in response to receiving remittance information from a first of the plurality of self-service apparatuses, the first server is configured to determine which of the one or more second servers is associated with the first self-service apparatus and is further configured to forward at least a portion of the remittance information received from the first self-service apparatus to the determined second server.

17. The remittance system of claim 16, further comprising:
a third server communicationally coupled to the one or more second servers wherein the second servers are configured to forward at least a portion of the remittance information to the third server; and
wherein the third server is further communicationally coupled with processing means configured to receive the at least a portion of remittance information and remit funds.

18. The remittance system of claim 16, further comprising:
a notification system communicationally coupled to the processing means and configured to automatically send an SMS message to a selected beneficiary informing him or her of the remittance.

19. The remittance system of claim 16, wherein the plurality of self-service apparatuses comprise input-output devices having unrestricted access.

20. The remittance system of claim 16, wherein each of the one or more second servers is associated with one or more of the plurality of self-service apparatuses based on the geographical location of each of the plurality of self-service apparatuses.

21. A device for transferring funds comprising:
a housing;
a card reader disposed within the housing and configured to accept a user membership card, wherein the user membership card initiates a transaction corresponding to transferring funds;
a processing unit configured to recognize a user account corresponding to the user membership card and process the transaction;
a display screen coupled to the processing unit and configured to display instructions of the transaction from the processing unit to a remitter;
a user input device coupled to the processing unit and configured to receive input from the remitter and send the input to the processing unit; and
a communication unit coupled to the processing unit and configured to send and receive communication corresponding to the transaction.

22. The device of claim 21, wherein the transaction occurs in a first country and the transaction corresponds to transfers funds to a second country.

23. The device of claim 21, wherein the display screen is further configured to display a beneficiary screen, wherein the beneficiary screen displays a list of at least one beneficiary of the transferred funds.

24. The device of claim 21, wherein the display screen is further configured to display a transfer amount screen, wherein the user may indicate the amount of funds to be transferred.

25. The device of claim 21, wherein the display screen is further configured to display a remittance purpose screen, wherein the user may indicate the purpose for the transaction.

26. The device of claim 21, further comprising:
the card reader configured to accept a mode of payment; and
the communication unit configured to transmit a payment account identifier of the mode of payment along with a membership account identifier of the user membership card.

27. The device of claim 21, wherein the communication unit is configured to receive a communication corresponding to a relationship between the payment account identifier and the membership account identifier.

28. The device of claim 21, wherein the device for transferring funds is accessible to the remitter at anytime.

29. The device of claim 21 further comprising:
A notification unit coupled to the processing unit for sending a notification to a beneficiary of the transferred funds when the transaction is processed.

30. A method for transferring funds comprising:
receiving remitter membership information;
activating a transaction in response to receiving the remitter membership information, wherein the transaction corresponds to transferring funds;
receiving a selection of at least one chosen beneficiary of the transaction from a list of at least one beneficiary from the remitter;
receiving a transfer amount for the funds from the remitter;
receiving user payment for the funds from the remitter;
determining the validity of the user payment; and
transferring the funds to the at least one chosen beneficiary from the remitter in a first country in response to determining the validity of the user payment.

31. The method of claim 30, wherein determining the validity of the remitter payment further comprises:
transmitting a portion of the remitter membership information along with a portion of the payment information corresponding to the remitter payment;
receiving a response code corresponding to a relationship between the portion of the remitter membership information and the portion of the payment information corresponding to the remitter payment; and
utilizing the response code to determining the validity of the remitter payment.

32. The method of claim 30, wherein the transferring the funds to the at least one chosen beneficiary from the remitter in the first country in response to determining whether the remitter payment is accepted further comprises transferring the funds to the at least one chosen beneficiary in a second country from the user in the first country.

33. The method of claim 30, further comprising:
Notifying the at least one beneficiary of the transferring of the funds.

34. The method of claim 30, prior to receiving the selection of at least one chosen beneficiary of the transaction:
displaying a beneficiary screen wherein the beneficiary screen displays the list of at least one beneficiary.

35. The method of claim 30, prior to receiving the transfer amount for the funds from the remitter:
displaying a transfer amount screen, wherein the transfer amount screen displays a numeric keypad wherein the remitter inputs the transfer amount.
